(19) United States
(12) Patent Application Publication
(10) Pub. No.: US 2015/0213110 A1
(43) Pub. Date: Jul. 30, 2015

(54) INFORMATION PROCESSING APPARATUS, SCORE CALCULATION METHOD, PROGRAM, AND SYSTEM

(71) Applicant: SONY CORPORATION, TOKYO (JP)

(72) Inventor: KAZUNORI ARAKI, KANAGAWA (JP)

(21) Appl. No.: 14/593,301

(22) Filed: Jan. 9, 2015

(30) Foreign Application Priority Data
Jan. 28, 2014 (JP) 2014-013644

(51) Int. Cl. G06F 17/30; G06F 11/14

(52) U.S. Cl. CPC G06F 17/30595; G06F 11/1451; G06F 2201/81

(57) ABSTRACT

There is provided an information processing apparatus including a calculation part configured to calculate a first score based on an operation log with respect to content using a weighting of an operation log that is different for each user attribute, and a linking part configured to link the calculated first score to the content.

### CROSS REFERENCE TO RELATED APPLICATIONS

This application claims the benefit of Japanese Priority Patent Application JP 2014-013644 filed Jan. 28, 2014, the entire contents of which are incorporated herein by reference.

### BACKGROUND

The present disclosure relates to an information processing apparatus, a score calculation method, a program, and a system. Recently, many methods have been proposed for extracting content from a large number of pieces of content from a viewpoint that a user desires.

For example, JP 2002-232823A discloses a communication apparatus that processes content in accordance with value-added information created on the basis of preference data including operation information (for example, fast forward and pause) at the time of playing back viewing content such as a movie or a drama.

### SUMMARY

In the related art described above, no weight is assigned to the operations such as “fast forward” and “pause” at the time of generating preference data of a user belonging to any attribute, and the pieces of data are used uniformly. However, there may be cases where the degrees of operations contributing to personal preference are different depending on users. For example, in the case of viewing photo content or the like on a smartphone, the degrees of each operation contributing to personal preference may be different between an operation performed by a user who is unused to the operation and an operation performed by an experienced user. That is, the inexperienced user may select, touch, or perform an enlarging operation on content by mistake.

Further, there may be cases where tendencies of operation logs differ from one another depending on attributes to which the users belong, for example, a user belonging to a certain attribute performs more enlarging operations on favorite photo content, and a user belonging to another attribute performs more tap operations on photo content.

In light of the foregoing, it is desirable to provide an information processing apparatus, a score calculation method, a program, and a system, which are capable of calculating a score showing user preference by assigning a different weight to an operation log with respect to content for each user attribute.

According to an embodiment of the present disclosure, there is provided an information processing apparatus including a calculation part configured to calculate a first score based on an operation log with respect to content using a weighting of an operation log that is different for each user attribute, and a linking part configured to link the calculated first score to the content.

According to another embodiment of the present disclosure, there is provided a score calculation method including calculating a first score based on an operation log with respect to content using a weighting of an operation log that is different for each user attribute, and linking the calculated first score to the content.

According to another embodiment of the present disclosure, there is provided a program for causing a computer to function as a calculation part configured to calculate a first score based on an operation log with respect to content using a weighting of an operation log that is different for each user attribute, and a linking part configured to link the calculated first score to the content.

According to another embodiment of the present disclosure, there is provided a system including a server including a calculation part configured to calculate a first score based on an operation log with respect to content using a weighting of an operation log that is different for each user attribute, and a linking part configured to link the calculated first score to the content, and a user terminal including a presentation part configured to present the content in accordance with highness of the first score or a second score linked to the content.

According to one or more of embodiments of the present disclosure, it becomes possible to calculate a score showing user preference by assigning a different weight to an operation log with respect to content for each user attribute.

Note that the effects described above are not necessarily limitative. With or in the place of the above effects, there may be achieved any one of the effects described in this specification or other effects that may be grasped from this specification.

### BRIEF DESCRIPTION OF THE DRAWINGS

FIG. 1 is a diagram illustrating an overview of a scoring system according to an embodiment of the present disclosure;

FIG. 2 is a block diagram illustrating a first overall configuration of a scoring system according to an embodiment of the present disclosure;

FIG. 3 is a diagram showing an example of a data configuration of an operation log;

FIG. 4 is a diagram showing an example of a data configuration of content information stored in a content DB;

FIG. 5 is a diagram showing an example of a data configuration of score information stored in a score information DB;

FIG. 6 is a diagram showing an example of a data configuration of user information stored in a user information DB;

FIG. 7 is a block diagram illustrating a second overall configuration of a scoring system according to an embodiment of the present disclosure;

FIG. 8 is a block diagram illustrating a third overall configuration of a scoring system according to an embodiment of the present disclosure;

FIG. 9 is a flowchart showing operation processing of a content analysis part of a server according to the present embodiment;

FIG. 10 is a flowchart showing calculation processing of scores stored in a score information DB 18 of the server according to the present embodiment;

FIG. 11 is a flowchart showing photo content-presentation control processing based on a score according to the present embodiment;

FIG. 12 is a diagram showing examples of operation logs with respect to a photo group of one user obtained by a test;

FIG. 13 is a diagram showing examples of operation logs with respect to a photo group of a plurality of users obtained by a test;

FIG. 14 is a diagram showing examples of pieces of metadata extracted from a photo group of one user;

FIG. 15 is a diagram showing examples of pieces of metadata extracted from a photo group of a plurality of users;

FIG. 16 is a diagram illustrating a case where top-scored (favorite) photo content is set to a front cover in a photo content list screen;

FIG. 17 is a diagram illustrating a case where pieces of photo content are arranged in order of score (order of preference) in a photo content list screen;

FIG. 18 is a diagram illustrating a case where pieces of top-scored (favorite) photo content are highlighted in a photo content list screen;

FIG. 19 is a diagram illustrating a case where a folder of top-scored (favorite) photo content is created;

FIG. 20 is a diagram illustrating a case where, in a photo content list screen sent by other users, photo content of a favorite user among the other users is preferentially displayed;

FIG. 21 is a diagram illustrating a case where pieces of unknown photo content are classified into photo content that a user likes and the other photo content;

FIG. 22 is a diagram illustrating presentation of candidates for pieces of photo content to be shared with a specific user;

FIG. 23 is a diagram illustrating a case where pieces of photo content that a user likes are extracted and presented from a large number of pieces of photo content shared by another user;

FIG. 24 is a diagram illustrating a case where pieces of photo content each including a favorite person are highlighted;

FIG. 25 is a diagram illustrating a case where pieces of information related to belongings of a favorite person are presented;

FIG. 26 is a diagram illustrating a case where pieces of favorite photo content are automatically backed up;

FIG. 27 is a diagram illustrating a case where pieces of favorite photo content are saved locally;

FIG. 28 is a table in which scores with respect to pieces of photo content of each user and item purchase logs of each user are normalized;

FIG. 29 is a diagram showing relation scores between pieces of photo content and items in a matrix;

FIG. 30A is a table in which relation scores between items and one piece of photo content are extracted and arranged in order of relation score;

FIG. 30B is a table in which relation scores between items and a plurality of pieces of photo content are extracted and arranged in order of relation score;

FIG. 31 is a diagram showing a screen display example in a case where related items are displayed at a time of viewing photo content P1; and

FIG. 32 is a diagram showing a screen display example in which items each related to photo content having high iScore are recommended to a user.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, the description will be given in the following order.

1. Overview of scoring system according to embodiment of present disclosure

2. Overall configuration
2-1. First configuration
   2-1-1. Configuration of server
   2-1-2. Configuration of user terminal
2-2. Second configuration
2-3. Third configuration

3. Score calculation
3-1. Basic operation
   3-1-1. Generation of content information
   3-1-2. Score calculation processing
   3-1-3. Presentation control processing
3-2. Calculation of Item-based Score
3-3. Calculation of Attribute-based Score
3-4. User test
   3-4-1. User test for enhancing accuracy of iScore
   3-4-2. User test for enhancing accuracy of aScore

4. Example of practical use of scores
4-1. Presentation control
4-2. Backup control

5. Application to content recommendation
5-1. CF-based content recommendation
5-2. CBF-based content recommendation
5-3. CF/CBF-based content recommendation

6. Conclusion

### 1. OVERVIEW OF SCORING SYSTEM ACCORDING TO EMBODIMENT OF PRESENT DISCLOSURE

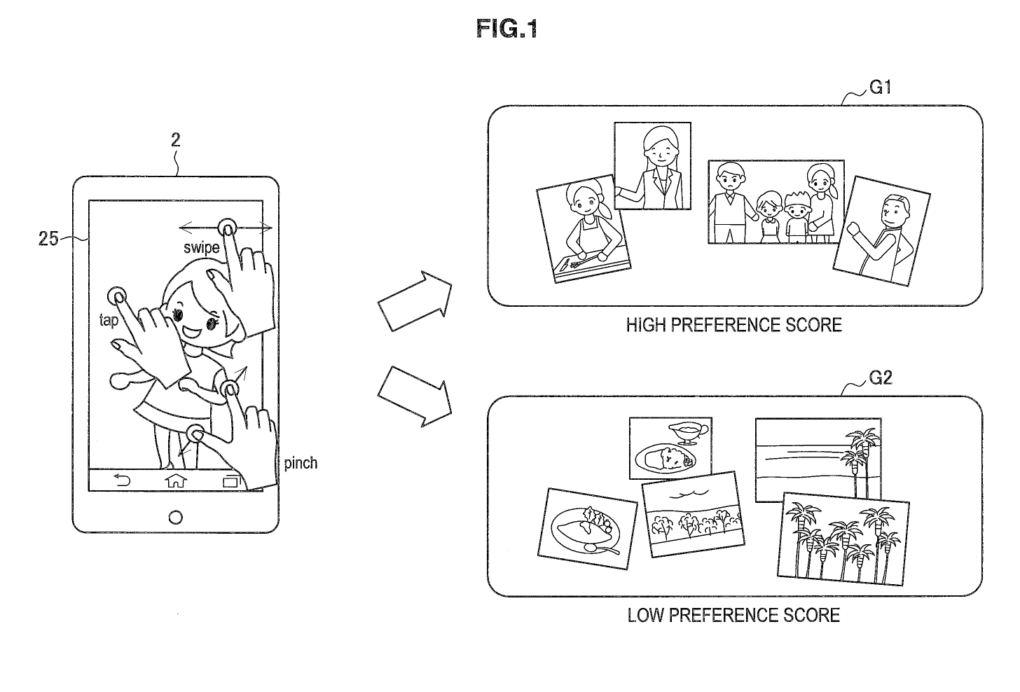

First, with reference to FIG. 1, an overview of a scoring system according to an embodiment of the present disclosure will be described. As shown in FIG. 1, a user terminal 2 according to the present embodiment is achieved by a smartphone, for example, and is provided with an operation display part 25 on one face. The operation display part 25 has a display function of displaying a screen and an operation input function of accepting input of user operation. To be specific, a touch sensor, which is an example of an operation input part, is provided in a stacked manner on a display screen, and may detect the user operation on the display screen.

The operation display part 25 of the user terminal 2 displays photo content in accordance with the user operation. A user selects photo content that the user wants to watch from a large number of photo content thumbnails by tapping the photo content to thereby cause the photo content to be subjected to full-screen display, and further perform enlarging operation and swipe operation on the full-screen displayed photo content. Records of such operations as a log show the number of times that the photo is displayed, the total display time of the photo, the number of times of performing zoom-in, and the number of times of performing zoom-out with respect to each piece of photo content.

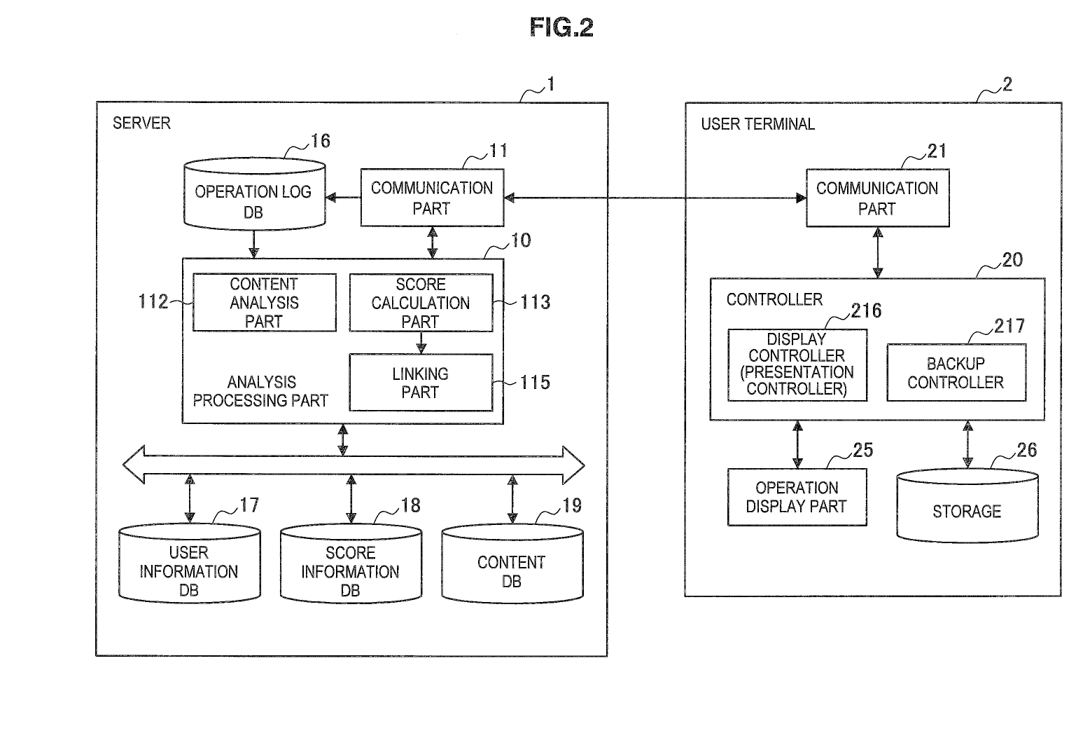

Then, by analyzing the recorded operation log, a score showing a user's preference with respect to photo content is calculated, and, on the basis of the calculated score, display control (presentation control) and backup control of the large number of pieces of photo content are performed. For example, as shown in FIG. 1, the large number of pieces of photo content may be divided into a group G1 for photo content having a high preference score and a group G2 for photo content having a low preference score. Further, the user terminal 2 according to the present embodiment can display the large number of pieces of photo content in a smart manner, for example, the photo content having a high preference score is automatically presented to the user, and a thumbnail of the photo content having a high preference score is displayed in a large size when a list of the large number of pieces of photo content are displayed in thumbnails. Note that the analyzing of the operation log and the calculation of the preference score may be performed in a server 1 (see FIG. 2) connected to the user terminal 2, or may be performed in the user terminal 2.

### Background

In the past, no weight has been assigned to the operations such as “fast forward” and “pause” with respect to a user belonging to any attribute, and the pieces of data are used uniformly. However, there may be cases where the degrees of operations contributing to personal preference are different depending on user attributes. That is, the tendencies of operations are different depending on the user attributes.

Accordingly, in the present embodiment, in the case of calculating a score showing a preference with respect to photo content, the calculation is performed by assigning different weights to operation logs for each user attribute. In this way, even in the case where the operation logs for pieces of photo content are the same, different preference scores are calculated when the user attributes are different. To be specific, for example, even in the case where an operation performed by a user who is unused to the operation of the user terminal 2 displaying the photo content and an operation performed by an experienced user are the same (for example, the number of times that the photo is displayed, the number of times of performing zoom-in, and the like are the same), the degrees of operation logs contributing to personal preference may be different from each other. That is, the degree of operation log of the experienced user contributing to the personal preference is high, but the degree of operation log of the inexperienced user contributing to the personal preference is low, since the operation log of the inexperienced user includes operation mistakes.

Heretofore, the overview of the scoring system according to an embodiment of the present disclosure has been described. Note that, although the present embodiment uses photo content as an example of content, the present disclosure is not limited thereto, and is also capable of calculating a preference score on the basis of an operation log with respect to another piece of content. Further, the user terminal 2 is not limited to the smartphone shown in FIG. 1, and may be a tablet terminal or a mobile phone terminal, for example. Subsequently, with reference to FIGS. 2 to 8, an overall configuration of the scoring system according to an embodiment of the present disclosure will be described.

### 2. OVERALL CONFIGURATION

### <2-1. First Configuration>

FIG. 2 is a block diagram illustrating a first overall configuration of a scoring system according to an embodiment of the present disclosure. As shown in FIG. 2, the scoring system according to an embodiment of the present disclosure includes a server 1 and a user terminal 2, and the server 1 calculates a preference score on the basis of an operation log transmitted from the user terminal 2. In this way, the processing load on the user terminal 2 can be reduced. Hereinafter, each component of the server 1 and the user terminal 2 included in the scoring system will be described specifically.

(2-1-1. Configuration of Server)

As shown in FIG. 2, the server 1 includes a communication part 11, an analysis processing part 10, an operation log DB 16, a user information DB 17, a score information DB 18, and a content DB 19.

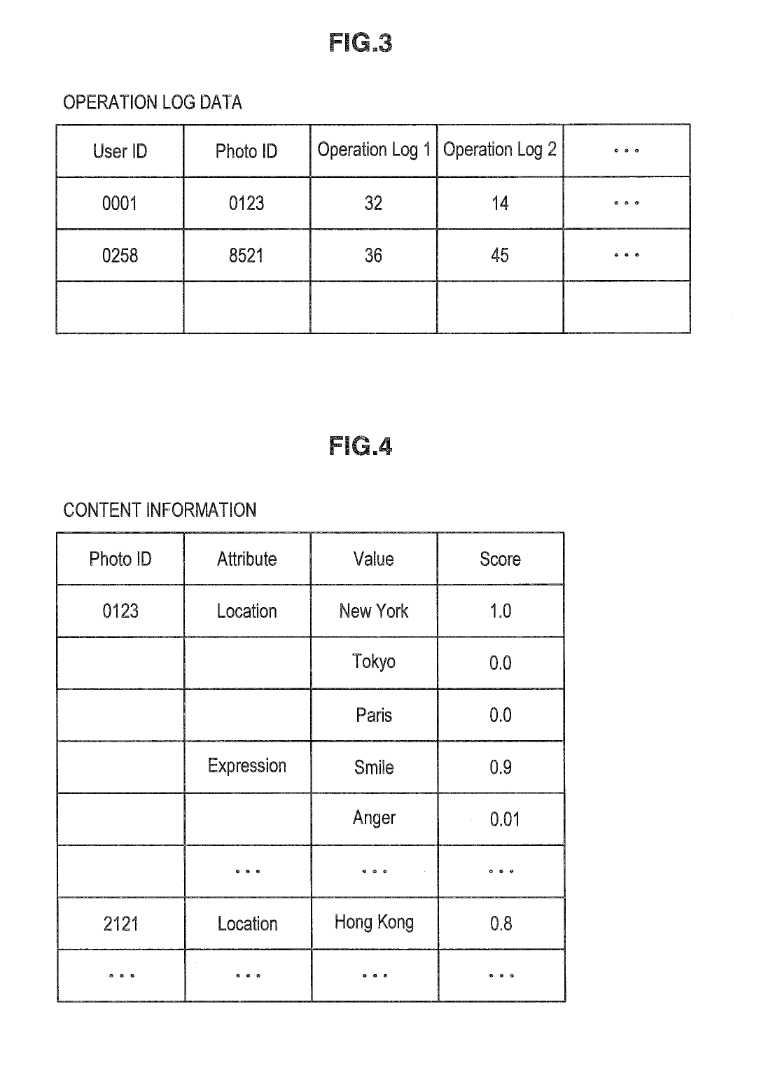

The communication part 11 connects with an external device via wire or radio, and has a function of transmitting and receiving data. The communication part 11 according to the present embodiment receives, from the user terminal 2, for example, photo content, an ID of the photo content (hereinafter, also referred to as photo ID), and an operation log with respect to the photo content. The operation log received by the communication part 11 is stored in the operation log DB 16. Here, an example of data configuration of the operation log stored in the operation log DB 16 is shown in FIG. 3. As shown in FIG. 3, the data of the operation log is formed from a user ID representing a user who has performed the operation, a photo ID representing photo content that is an operation target, an operation log 1 and an operation log 2 which are logs of operations, and the like. The operation log 1 may be the number of taps, and the operation log 2 may be the number of enlarging operations (pinch-open operations), for example.

The analysis processing part 10 analyzes the photo content received by the communication part 11 from the user terminal 2 and the operation logs stored in the operation log DB 16. To be specific, the analysis processing part 10 functions as a content analysis part 112, a score calculation part 113, and a linking part 115.

The content analysis part 112 analyzes the photo content and extracts metadata. The metadata may be extracted from condition information (Exif: Exchangeable Image File Format) when creating an image, which is added to the image at the time of shooting, for example, and in addition, may include rich metadata obtained by image analysis. Examples of the metadata extracted from Exif include a shooting date/time, a shooting location, a name of manufacturer of a shooting device (manufacturer/distributor), a model name of a shooting device (model name of camera-equipped mobile phone/smartphone or the like), a resolution of a whole image, a resolution per unit in horizontal/vertical direction, a shooting direction, a shutter speed, and a diaphragm (F value). Examples further include an ISO speed, a photometric mode, availability of flash, an exposure correction step value, a focal distance, a color space, GPS information (latitude/longitude/altitude, and the like), and a thumbnail.

The rich metadata includes subject information (person recognition information, object recognition information). For example, examples of face metadata includes with/without face, a size of a face, the number of faces, a direction of a face, a position of a face, an age, a generation, a sex, a level of smile, a level of anger, a score of looking into the camera, with/without glasses, a race, a person score (who the subject is), and a target object score (what the subject is). Further, examples of image metadata include a color histogram, a texture, an edge feature quantity, a color variance (0 (uniform color)-255), and blur score (0 (blur)-255 (clear)).

The content analysis part 112 stores, in the content database (DB) 19, the extracted metadata as a content profile (CP) associated with an ID of the photo content.

The score calculation part 113 calculates a score showing a user's preference with respect to photo content (preference score) on the basis of an operation log after assigning different weighting to each user attribute. Here, the score calculation part 113 calculates, as a first score based on an operation log with respect to content (an example of a preference score), “Item-based Score” (hereinafter, also referred to as iScore).

Further, in the case where there is no operation log in photo content (in the case where it is an unknown image that the user has not operated), the score calculation part 113 may calculate, as a second score based on metadata of the photo content (an example of a preference score), “Attribute-based Score” (hereinafter, also referred to as aScore). The calculation of the preference score performed by the score calculation part 113 will be described specifically in “3. Score calculation”.

The linking part 115 links a score calculated by the score calculation part 113 to photo content (to be specific, an ID of the photo content), and stores the calculated score linked to the photo content in the score information DB 18. Further, the linking part 115 may also store in the score information DB the calculated score associated with a user ID.

The content DB 19 stores a result obtained by analysis performed by the content analysis part 112. Here, FIG. 4 shows an example of a data configuration of content information stored in the content DB 19. As shown in FIG. 4, to each ID of photo content (photo ID), metadata of shooting location (Attribute: Location) and metadata of an expression of a subject (Attribute: expression) are associated. Alternatively, aScore is linked to each metadata.

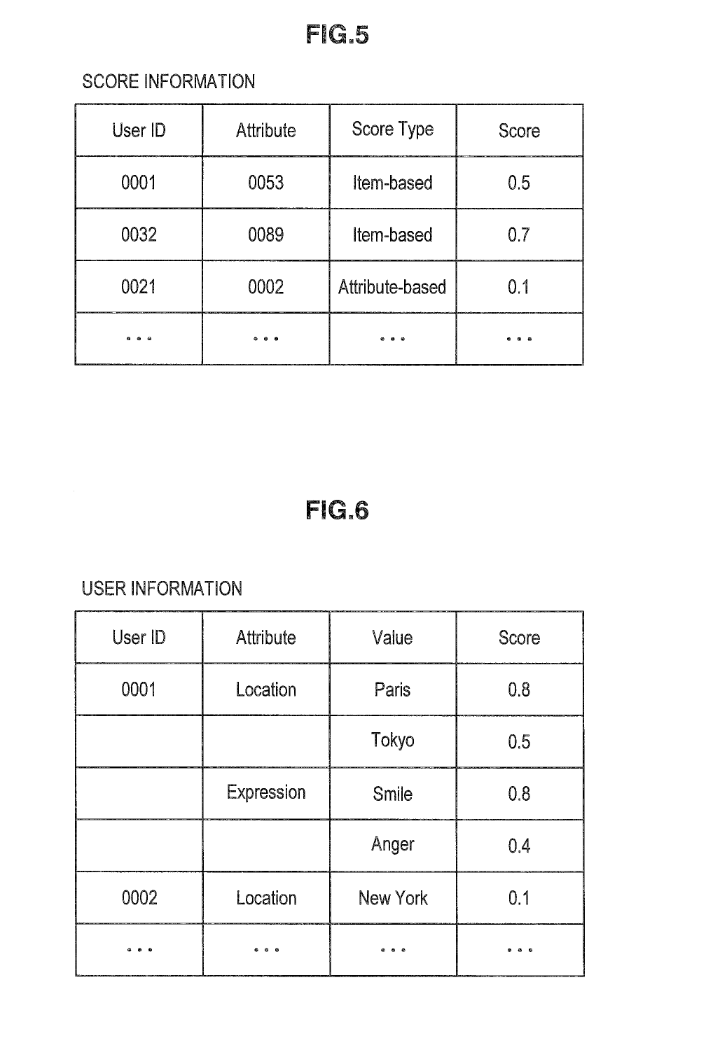

In the score information DB 18, the score (iScore/aScore) calculated by the score calculation part 113, which is linked to the photo ID by the linking part 115, is stored. Here, FIG. 5 shows an example of a data configuration of score information stored in the score information DB 18. As FIG. 5, to the user ID and the photo ID, “Item-based Score” or “Attribute-based Score” is linked.

The user information DB 17 stores information showing a meta-level user preference. FIG. 6 is a diagram showing an example of a data configuration of user information stored in the user information DB 17. As shown in FIG. 6, meta-level “Attribute-based Score” (an example of preference score) is stored for each user ID. For example, a user of ID “0001” has the preference score of the shooting location metadata “Paris” of “0.8” and the preference score of the shooting location metadata “Tokyo” of “0.5”, it can be understood that the user prefers photo content shot in “Paris” to photo content shot in “Tokyo”.

Heretofore, the configuration of the server 1 has been described specifically. Subsequently, the configuration of the user terminal 2 will be described specifically.

(2-1-2. Configuration of User Terminal)

As shown in FIG. 2, the user terminal 2 includes a controller 20, a communication part 21, an operation display part 25, and a storage 26. Hereinafter, each component will be described.

The controller 20 is configured from a microcomputer including a central processing unit (CPU), read only memory (ROM), random access memory (RAM), non-volatile memory, and an interface, for example, and controls each component of the user terminal 2. For example, the controller 20 performs control in a manner that a log of a user operation with respect to photo content detected by the operation display part 25 is transmitted to the server 1 with the ID of the photo content through the communication part 21. In this case, the controller 20 may also transmit a user ID together.

Further, the controller 20 also functions as a display controller (presentation controller) 216 and a backup controller 217. The display controller 216 performs display (presentation) control of photo content on the basis of the score (iScore or aScore, or a score obtained by multiplying those by a mixed weight) of each photo content acquired from the server 1. The display (presentation) of the photo content based on the score will be described specifically in “4. Example of practical use of scores”. Further, the backup controller 217 keeps the photo content stored in the storage 26, which is local memory, by transferring the photo content to a given cloud server. The backup controller 217 according to the present embodiment may also perform backup control of the photo content on the basis of the score of each photo content acquired from the server 1. The backup of the photo content based on the score will also be described specifically in “4. Example of practical use of scores”.

The communication part 21 connects with an external device via wire or radio, and has a function of transmitting and receiving data. The communication part 21 according to the present embodiment connects with the server 1, for example, and transmits photo content, an ID of the photo content, and an operation log with respect to the photo content. Further, the communication part 21 receives, from the server 1, the score (iScore or aScore, or a score obtained by multiplying those by a mixed weight) associated with the ID of the photo content.

As described above with reference to FIG. 1, the operation display part 25 has an operation input function and a display function. The operation input function is specifically achieved by a touch sensor which accepts an operation input on a display screen. Further, the display function is achieved by a liquid crystal display (LCD) or an organic light-emitting diode (OLED), for example.

The storage 26 is local memory, and stores a program and the like used for the controller 20 to execute various processes. Further, the storage 26 stores photo content.

Heretofore, the first configuration of the scoring system according to an embodiment of the present disclosure has been described specifically. Note that the scoring system according to an embodiment of the present disclosure is not limited to the first configuration, and may have configurations as described below, for example.

<2-2. Second Configuration>

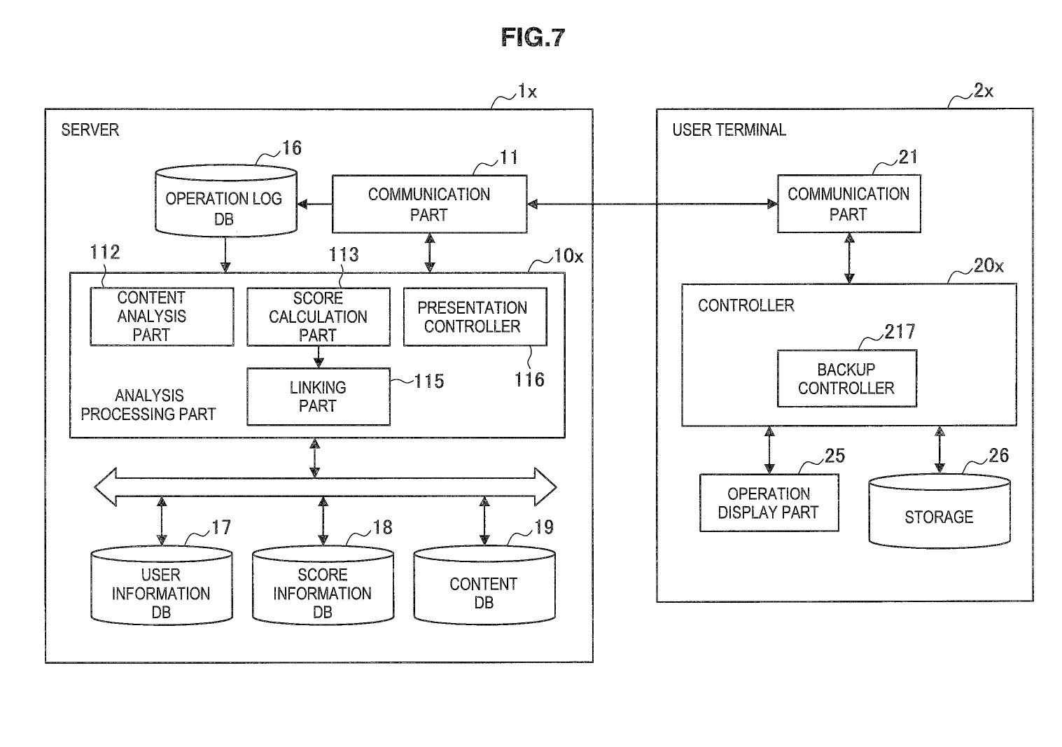

In the first configuration, the display controller 216 which displays (presents) the photo content on the basis of the score is included in the user terminal 2, but the server 1 may have the function of the display controller 216. Hereinafter, with reference to FIG. 7, a server 1x which has a function of performing display (presentation) control of photo content on the basis of a score will be described.

FIG. 7 is a block diagram illustrating a second overall configuration of a scoring system according to an embodiment of the present disclosure. As shown in FIG. 7, the scoring system includes the server 1x and a user terminal 2x. The server 1x includes, in addition to the components included in the server 1 according to the first configuration, a presentation controller 116.

The presentation controller 116 performs display (presentation) control of photo content on the basis of the score (iScore or aScore, or a score obtained by multiplying those by a mixed weight) of each photo ID stored in the score information DB 18. To be specific, the presentation controller 116 performs control in a manner that information for generating a display screen of photo content based on the score is transmitted to the user terminal 2x through the communication part 11. A controller 20x of the user terminal 2x performs control in a manner that the display screen of photo content generated on the basis of the information received from the server 1x is displayed on the operation display part 25.

The functions of the other components are the same as the functions of the components having the same reference numerals, respectively, described with reference to FIG. 2, and hence, the description thereof will be omitted. The scoring system according to the second configuration described above can further reduce the processing load on the user terminal 2 compared to the first configuration.

<2-3. Third Configuration>

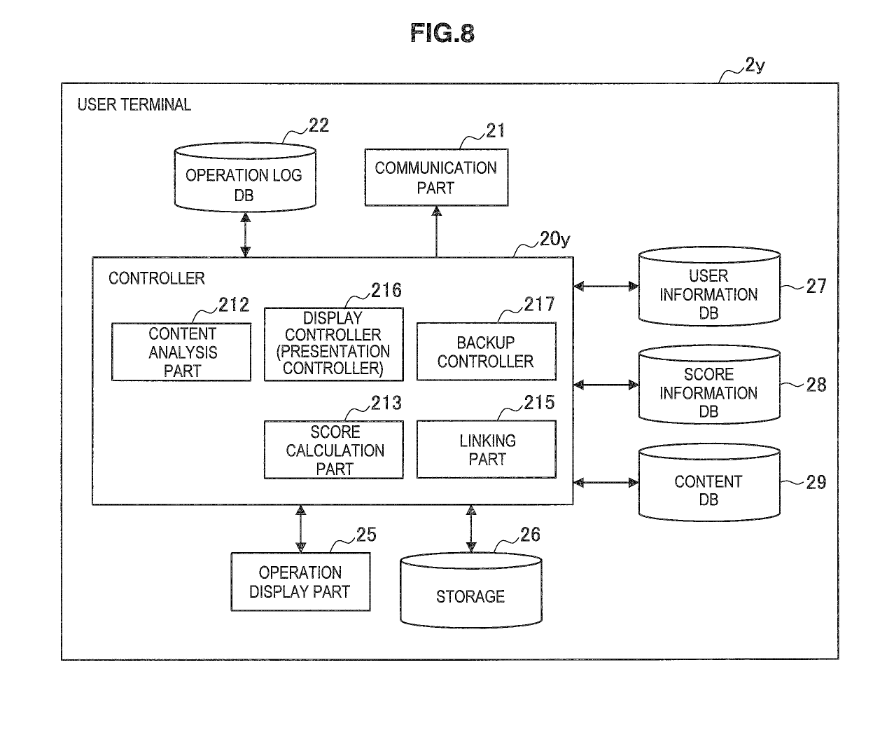

Further, in the scoring system according to an embodiment of the present disclosure, the user terminal 2 may have the main functions of the server 1 according to the first configuration. Hereinafter, with reference to FIG. 8, specific description will be given.

FIG. 8 is a block diagram illustrating a third overall configuration of a scoring system according to an embodiment of the present disclosure. As shown in FIG. 8, the scoring system according to the third configuration is achieved by a user terminal 2y. The user terminal 2y includes a controller 20y, a communication part 21, an operation log DB 22, an operation display part 25, a storage 26, a user information DB 27, a score information DB 28, and a content DB 29. The controller 20y controls each component of the user terminal 2y. Further, the controller 20y performs control in a manner that a log of a user operation with respect to photo content detected by the operation display part 25 is stored in the operation log DB 22 with the ID of the photo content.

Further, the controller 20y also functions as a content analysis part 212, a score calculation part 213, a linking part 215, a display controller (presentation controller) 216, and a backup controller 217.

In the same manner as the content analysis part 112 according to the first configuration, the content analysis part 212 analyzes the photo content and extracts metadata. The extracted metadata is linked to the ID of the photo content and stored in the content DB 29.

In the same manner as the score calculation part 113 according to the first configuration, the score calculation part 213 calculates a score showing a preference with respect to photo content on the basis of an operation log stored in the operation log DB 22 using different weighting of the operation log for each user attribute.

The linking part 215 links the score calculated by the score calculation part 213 to the photo content (to be specific, ID of the photo content) and stores the score linked to the photo content in the score information DB 28. Further, the linking part 215 may also store in the score information DB the calculated score associated with a user ID.

The display controller (presentation controller) 216 performs display (presentation) control of photo content on the basis of the score (iScore or aScore, or a score obtained by multiplying those by a mixed weight) of each photo content stored in the score information DB 28.

The backup controller 217 performs backup control of the photo content on the basis of the score of each photo content stored in the score information DB 28.

In the scoring system according to the third configuration described above, all of the main processes according to an embodiment of the present disclosure such as the score calculation of the photo content and display (presentation) control of the photo content based on the score can be performed within the user terminal 2y.

### 3. SCORE CALCULATION

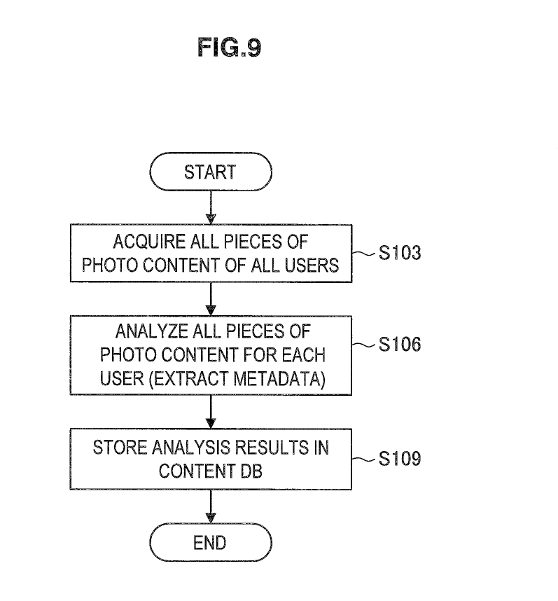

Subsequently, with reference to FIGS. 9 to 15, score calculation processing performed by the scoring system according to the present embodiment will be described specifically. Note that the score calculation processing performed by the scoring system according to first configuration described with reference to FIG. 2 will be described as an example.

<3-1. Basic Operation>

First, with reference to FIGS. 9 to 11, a basic operation processing of the scoring system according to the present embodiment will be described.

(3-1-1. Generation of Content Information)

FIG. 9 is a flowchart showing operation processing of the content analysis part 112 of the server 1 according to the present embodiment. As shown in FIG. 9, first, in Step S103, the content analysis part 112 acquires all pieces of photo content of all users from the user terminal 2. Note that, although there is shown the processing of acquiring all pieces of photo content of all users as an example, the present embodiment is not limited thereto, and the same processing may be performed also in the case where at least one piece of photo content of at least one user is acquired.

Next, in Step S106, the content analysis part 112 analyzes all pieces of photo content for each user. To be specific, the content analysis part 112 extracts metadata of the pieces of photo content.

Subsequently, in Step S109, the content analysis part 112 stores in the content DB 19 the analysis results (to be specific, extracted metadata) as content information.

(3-1-2. Score Calculation Processing)

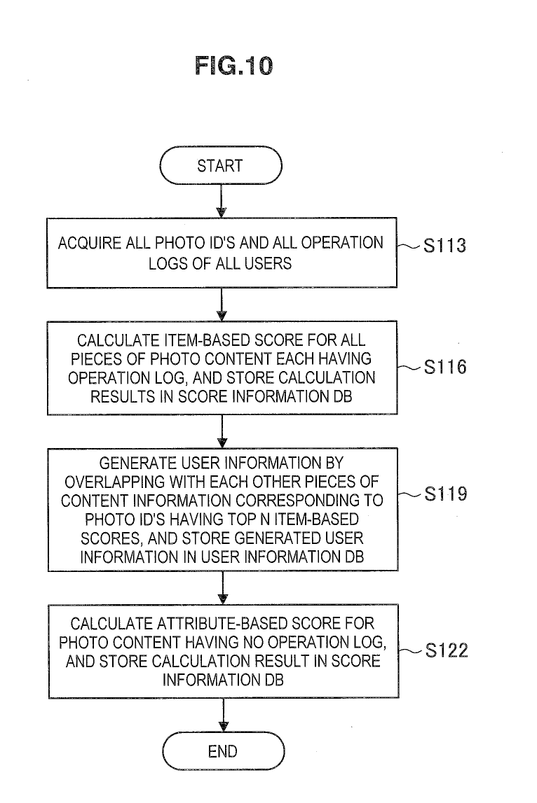

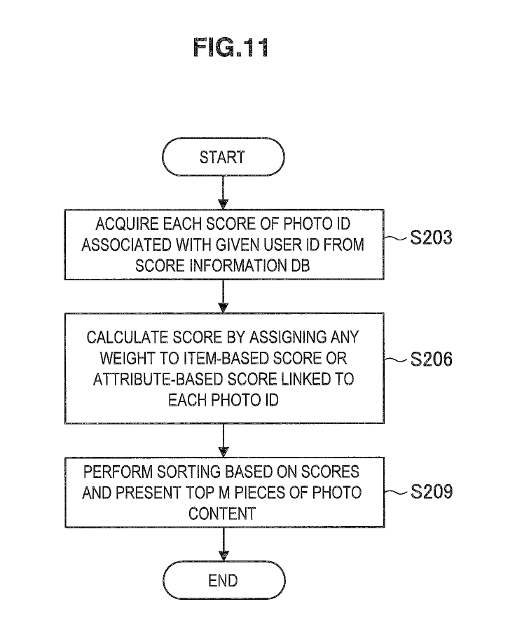

FIG. 10 is a flowchart showing calculation processing of scores stored in the score information DB 18 of the server 1 according to the present embodiment. As shown in FIG. 10, first, in Step S113, the score calculation part 113 of the server 1 acquires all photo ID's and all operation logs of all users. Note that, although there is shown the processing of acquiring all photo ID's and all operation logs of all users as an example, the present embodiment is not limited thereto, and the same processing may be performed also in the case where at least one photo ID and at least one operation log of at least one user is acquired.

Next, in Step S116, the score calculation part 113 calculates iScore on the basis of the operation log with respect to all pieces of photo content in which the operation log exists, and the calculation results are each linked to the ID of the photo content by the linking part 115 and are stored in the score information DB 18. The method of calculating iScore performed by the score calculation part 113 will be described in detail later in “3-2. Calculation of Item-based Score”.

Subsequently, in Step S119, the linking part 115 generates all-user information by overlapping pieces of content information (metadata) with each other, the pieces of content information corresponding to photo ID's of pieces of photo content having the top N iScores among all pieces of photo content stored in the score information DB 18, and stores the all-user information in the user information DB 17. As shown in FIG. 6, the user information is data showing a meta-level user preference, and a score of each metadata (attribute) is generated for each user ID.

Next, in Step S122, the score calculation part 113 calculates aScore for photo content in which the operation log does not exist, and the calculation result is linked to the ID of the photo content by the linking part 115 and is stored in the score information DB 18. The method of calculating aScore performed by the score calculation part 113 will be described in detail later in “3-3. Calculation of Attribute-based Score”.

(3-1-3. Presentation Control Processing)

FIG. 11 is a flowchart showing photo content-presentation control processing based on a score according to the present embodiment. As shown in FIG. 11, first, in Step S203, the user terminal 2 acquires each score (iScore/aScore) of a photo ID associated with a given user ID from the score information DB 18 of the server 1.

Next, in Step S206, the display controller (presentation controller) 216 calculates a score by assigning any weight to iScore or aScore linked to each photo ID. To be specific, the display controller 216 calculates the score using the following Equation 1.

Score=wi*iScore+wa*aScore (Equation 1)

Note that, in Equation 1, “wi” represents an item-based mixed weight, and “wa” represents an attribute-based mixed weight.

Since iScore is a score based on the operation log of the user with respect to the photo content, the degree of contribution to the personal preference is high. However, since aScore is calculated on the basis of a degree of similarity of the photo content in which iScore is calculated when the operation log does not exist, the degree of contribution to the personal preference is low. Accordingly, in the case of performing presentation processing on the basis of the both scores, the photo content corresponding to the user's preference can be presented more reliably, by using a score obtained by assigning more weight to iScore having higher degree of contribution to the personal preference.

For example, in the case where the ratio of the mixed weight wi:wa is set to 2:1, the score of each photo content can be calculated as follows.

TABLE 1

| | Score | Weight | Calculation result |
|---|---|---|---|
| Photo A | 0.5 (iScore) | 2 | 1.0 |
| Photo B | 0.7 (aScore) | 1 | 0.7 |
| Photo C | 0.8 (aScore) | 1 | 0.8 |

The calculation of the score using the mixed weight described above may be performed in the server 1 (to be specific, score calculation part 113).

Subsequently, in Step S209, the display controller 216 sorts all pieces of photo content of the user on the basis of scores, and performs control in a manner that the top M pieces of photo content are presented.

In this way, the user terminal 2 can automatically present the pieces of photo content corresponding to the user's preference among a large number of pieces of photo content. Further, also the unknown photo content in which the operation log does not exist can be presented as the photo content corresponding to the user preference by calculating aScore. The user can even more enjoy viewing photo content with the presentation of unknown photo content that matches the user's preference.

<3-2. Calculation of Item-Based Score>

Subsequently, calculation of Item-based Score (iScore) performed by the score calculation part 113 will be described. The score calculation part 113 represents a user's preference with respect to photo content by a score on the basis of an operation log (feedback) of the user with respect to the photo content. The operation log includes a photo selecting operation, a tap operation, a zoom-in/out operation, a sharing operation, a printing operation, and the like. Further, in the case where the photo content is viewed on a device capable of detecting a line of sight of the user, the operation log also includes a time period of the user gazing the photo content and the number of times the user gazes the photo content.

To be more specific, the score calculation part 113 calculates Item-based Score using the following Equation 2.

$$Item - based Score = {\sum }_{i = 1}^{m} {w}_{i} Action {Log}_{i} \qquad ( Equation 2 )$$

In Equation 2, i represents a type number (i=0, 1, 2, . . . m) of the operation log, wᵢ represents a weight with respect to the operation log i, and ActionLogᵢ represents a value obtained by representing the operation log i by a score. For example, in the case where a score corresponding to the user's preference using the number of times of performing zooming and the time period of gazing a photograph, the following is satisfied.

Item-based Score=w1*number of times of performing zooming+w2*gaze time period

Note that, here, it is assumed as follows: “the larger the number of times of performing zooming, and the longer the time period of gazing, the score of the preference with respect to the photograph is higher”.

Further, although the operation log and the weight with respect to the operation log are set in accordance with a viewpoint to be represented by a score, the operation log and the weight with respect to the operation log may also be determined by a user test and the like. For example, an actual operation log and a result obtained by a user explicitly performing rating (user evaluation) from a certain viewpoint are correlated with each other to thereby create a prediction model (or classification model), and, by using the model, an operation log contributing to the desired viewpoint is determined and the weight of the operation log is increased.

However, in the case where the weight with respect to the operation log is determined using the user test, since there is a case where the tendency of the operation log varies depending on the user attribute, the accuracy may be low even if a model is created by mixing operation logs having different distribution. That is, there is assumed a situation where the model may fit everybody to a certain extent, but may not be very accurate for individuals. Note that the user attribute is an attribute based on at least one of an age, a sex, a marital status, a parental status, a usage history of the user terminal 2, a model of a device being used, a learning level of operations, a usage history of a specific service/device, a usage frequency of a specific device, and a usage frequency/method of content, for example.

Accordingly, the present embodiment performs clustering on users on the basis of the user attributes and the tendency of the operation logs, and determines the weight of the operation log by performing model construction for each cluster.

For example, a user having a short usage history (operation history) of the user terminal 2 (for example, smartphone) is likely to do erroneous operation, and hence, it is assumed that the degree of the pinch-close/open operation contributing to the preference is low compared to a user having a long usage history. To be specific, a model is created based on “terminal usage history: short/long”, and in the case where it becomes clear that the degree of contribution of the pinch-close/open operation performed by the user belonging to the attribute of “terminal usage history: short” is low, the weight of the pinch-close/open operation log of the user belonging to the attribute of “terminal usage history: short” is set to be weak.

In this way, in the present embodiment, the scores of various types of content are calculated by assigning different weights to the operation logs for the respective user attributes, and hence, a user's preference can be represented by a score more reliably. Note that the way of assigning a weight to the operation log (specific example of the user test) according to the present embodiment will be described specifically later in “3-4. User test”.

Further, in the case where, when viewing photographs of another user under the state in which a plurality of users can view each other's photographs like the state of SNS, a degree of similarity of a viewing user with respect to another user is provided in advance, Item-based Score taken into account the degree of similarity to the another user can be calculated using the following Equation 3. In this way, the score with respect to the photograph of the another user having a high degree of similarity becomes high.

$$Item - based {Score}_{k} = ( {\sum }_{i = 1}^{m} {w}_{i} Action {Log}_{i} ) {u}_{k} \qquad ( Equation 3 )$$

In Equation 3, i represents a type number (i=0, 1, 2, . . . m) of the operation log, wᵢ represents a weight with respect to the operation log i, ActionLogᵢ represents a value obtained by representing the operation log i by a score, and uₖ represents a similarity score with respect to another user k.

The degree of similarity (similarity score) with respect to another user represents a degree of interchange or a degree of intimacy with the another user. Further, examples of the another user include a creator of (a person who took) photo content, an owner, a contributor, and a subject of photo content, and the like.

<3-3. Calculation of Attribute-Based Score>

The above-mentioned iScore is obtained by representing by a score the user's preference with respect to the photo content on the basis of the operation log in the case where the operation log of the photo content exists, but the present embodiment is not limited thereto, and is also capable of representing by a score the preference with respect to the photo content in which the operation log does not exist.

To be specific, the score calculation part 113 calculates Attribute-based Score (aScore) on the basis of the degree of similarity of metadata with metadata of photo content having high iScore, using the following Equation 4. Then, the top N aScores are presented as pieces of photo content that the user likes.

Attribute-based Score=sim(photo(j),photo(k)) (Equation 4)

In Equation 4, photo(j) represents photo content having high iScore. Further, photo(k) represents photo content ki to kn having no operation log, and the pieces of photo content ki to kn are sequentially compared to photo(j) to thereby calculate aScores.

The metadata of the photo content to be used for the calculation of aScore is extracted from the photo content by the content analysis part 112 as described above, and, for example, may be metadata extracted from Exif or may be rich metadata extracted on the basis of image analysis. The richer metadata includes with/without face, expression, person recognition (sex, age, who the person is, and the like), and object recognition, for example.

Further, for the degree of similarity of the metadata, the following may be used: Cosine, Pearson correlation coefficient, Mahalanobis, Kullback-Leibler distance, Euclid, and the like. Further, Attribute weights may be set for the respective pieces of metadata to thereby provide aScores with strength and weakness. Hereinafter, using Examples 1 to 3, specific examples in the case where Attribute weights for the respective pieces of metadata are provided with strength and weakness will be described.

### Example 1

### Making Location and Time Strong

By making Attribute weight with respect to location metadata and time metadata strong, unknown photo content (in which the operation log does not exist) which is similar in terms of location and time to the photo content having top iScore can be presented as photo content that the user likes. In this way, a user experience that the user feels like the following can be realized: “I have also seen this scene at this time in this location.”

### Example 2

### Making Person Score Strong

By making Attribute weight with respect to metadata (person score) of person recognition (who the person is) strong, unknown photo content which has a person group as subjects shown in the photo content having top iScore can be presented as photo content that the user likes. In this way, a user experience that the user feels like the following can be realized: “I remember that there is another photograph having this person.”

### Example 3

### Making Location and Time, and Person Score Strong

By satisfying both Example 1 and Example 2, unknown photo content which is similar in terms of location and time to the photo content having top iScore and which has a person group shown in the photo content having top iScore can be presented as photo content that the user likes. Note that the weight ratio of the “location and time” metadata to the “person score” metadata may be set in advance or may be personalized.

In the same manner as the way of assigning weight to the operation log at the time of calculating iScore, Attribute weight described above can also be determined by a user test. For example, Attribute weight of metadata that is included in common in a high-score photo group (photo content group having high iScore) obtained by a user explicitly performing rating from a certain viewpoint is made strong.

Further, clustering on users based on the user attributes and the like may be performed, and then fitting may be performed within a cluster.

For example, let us assume that a user who has a child tends to like photographs of children compared to the users who do not have any child. To be specific, a model is created by dividing the users based on “parental status”, and, in the case where it becomes clear that with/without person metadata and age metadata of the users belonging to the attribute of “with child(ren)” are likely to contribute to the preference, Attribute weights for those pieces of metadata are set to be strong for the users belonging to the attribute of “with child(ren)”.

Further, let us assume that a user who owns a high-class camera (single-lens reflex camera, for example) tends to like photographs with high quality (low score of composition blur, high image quality, for example) compared to the users who do not own any high-class camera. To be specific, a model is created by dividing the users based on “owner/non-owner of high-class camera”, and, in the case where it becomes clear that pieces of metadata of a score representing composition blur and image quality of the users belonging to the attribute of “owner of high-class camera” are likely to contribute to the preference, Attribute weights for those pieces of metadata are set to be strong for the users belonging to the attribute of “owner of high-class camera”.

In this way, in the present embodiment, the scores of various types of content are calculated by assigning weights corresponding to user attributes to the pieces of metadata, and hence, a user's preference can be represented by a score more reliably. Note that the way of assigning a weight to the metadata (specific example of the user test) according to the present embodiment will be described specifically later in “3-4. User test”.

Heretofore, the calculation of iScore and the calculation of aScore have been described. Note that, when presenting pieces of photo content on the basis of the scores, the presentation may be performed on the basis of the scores obtained by multiplying iScore and aScore by any weight (see Step S206 shown in FIG. 11).

<3-4. User Test>

Subsequently, there will be described a way of assigning a weight to operation log/metadata (specific example of the user test). Here, it is intended to enhance the accuracy of iScore by finding out an operation log contributing to the preference, and to enhance the accuracy of aScore by finding out metadata contributing to the preference.

(3-4-1. User Test for Enhancing Accuracy of Item-Based Score)

To be specific, the following are performed.

(A) Allow a user (test subject) to use a photo viewer for a certain period of time, and acquire an operation log during the certain period of time.
(B) After completing the test, let the user explicitly evaluate (perform rating of) the photo content used for the test.
(C) Create a model that predicts the rating from the operation log.

Using the prediction model created by performing the above steps, an operation log contributing to a desired viewpoint (operation log contributing to a preference) can be found and the accuracy of iScore can be enhanced.

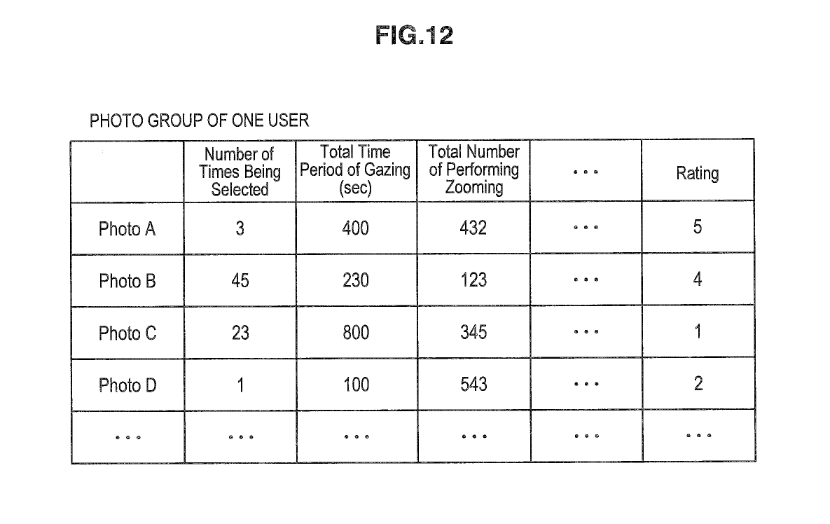

Hereinafter, the creation of the prediction model will be described with specific examples. FIG. 12 is a diagram showing examples of operation logs with respect to a photo group (photo content group) of one user (test subject) obtained by a test. As shown in FIG. 12, a user is caused to use Photos A to D for a certain period of time, and operation logs during the certain period of time are acquired, each of the operation logs including the number of times being selected, the total time period of gazing, the total number of performing zooming, and the like. After completing the test, the user is asked to explicitly evaluate (perform rating of) Photos A to D. A regression model or a classification model are created on the basis of those pieces of data, and thus, an operation log having a high degree of contribution to the rating can be found. Further, the created model is evaluated (recall, precision, accuracy) by cross variation or the like, and good or bad of the model can be determined.

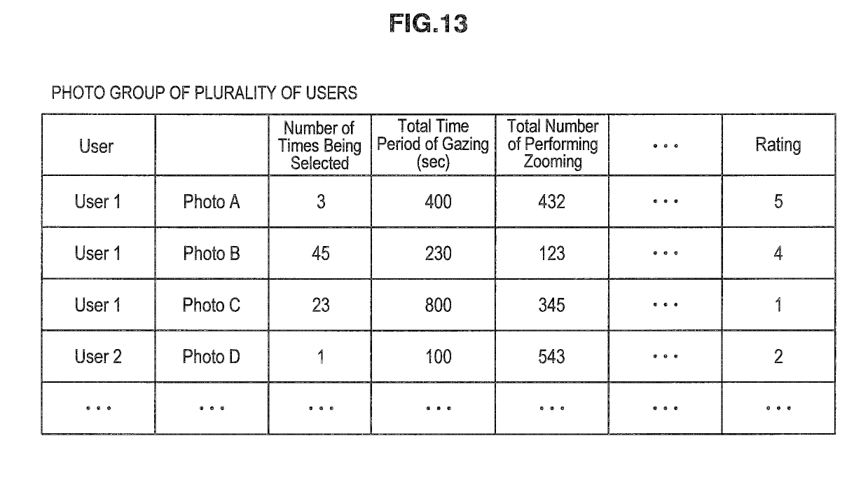

Further, also a prediction model can be created on the basis of test results of a plurality of users (test subjects). FIG. 13 is a diagram showing examples of operation logs with respect to a photo group of a plurality of users (test subjects) obtained by a test. As shown in FIG. 13, operation logs (score of operation log: feature vector) during a certain period of time with respect to the photo group of the plurality of users (User 1, User 2, . . . ) are acquired, and, after completing the test, rating is performed. Then, by analyzing the operation logs and the ratings, an operation log having a high degree of contribution to the rating that is common to the plurality of users can be found. The plurality of users are extracted as similar people as a result of performing clustering based on user attributes which are obtained by carrying out a questionnaire survey in advance, or extracted as people who have similar way of usage by performing clustering on the operation logs, so that the variation of the operation logs (feature quantity vectors) may become small. The items of the questionnaire survey include an operation history, a frequency of photo shooting, a way of saving photographs, a main subject target, a marital status, a parental status, a sex, an age, shooting equipment, and the like.

Subsequently, there will be described an example of a technique of analyzing the operation logs and the ratings acquired by the user. For example, in the case of acquiring two types of operation logs, test data is set in accordance with a data format {X1, X2, Y} (X1 and X2 each represent an operation log, Y represents a rating value), and the analysis is performed using an analysis tool. The analysis tool used here is not particularly limited. Further, in the case where the problem setting to be solved is a classification problem, the classification is performed by a decision tree, and in the case where the problem setting to be solved is a regression problem, the classification is performed by logistic regression, and thus, more accurate model can be created.

Note that, in the case where a prediction model is created by using the scores (feature quantities) of the operation logs shown in FIG. 12 and FIG. 13 as they are, there may be a case where an unintended model may be created. To be specific, for example, the difference between a degree of preference of a person who has viewed Photo A for 100 hours and a degree of preference of a person who has viewed Photo A for 200 hours is not so large, and it is estimated that the degrees of preferences are about the same at the point when they reached a certain level. Accordingly, a prediction model more suitable to the intention can be created by using for the prediction model the score of the operation log converted by the logit function or the like in accordance with the characteristics of the operation log. For example, by converting the time period of gazing using the logit function, the following can be achieved: the difference between the score of the operation log of three seconds and the score of the operation log of 100 seconds is large, but on the other hand, the difference between the score of the operation log of 100 hours and the score of the operation log of 200 hours is small.

Heretofore, the iScore-accuracy enhancement using the user test has been described in detail. Subsequently, aScore-accuracy enhancement using the user test will be described.

(3-4-2. User Test for Enhancing Accuracy of Attribute-Based Score)

To be specific, the following are performed.

(a) Extract metadata from photo content to be a test target included in a photo viewer.
(b) Let a user explicitly evaluate (perform rating of) the photo content of the test target.
(c) Create a model that predicts the rating from configuration of the metadata.

Using the prediction model created by performing the above steps, metadata contributing to a desired viewpoint (metadata contributing to a preference) can be found and the accuracy of aScore can be enhanced.

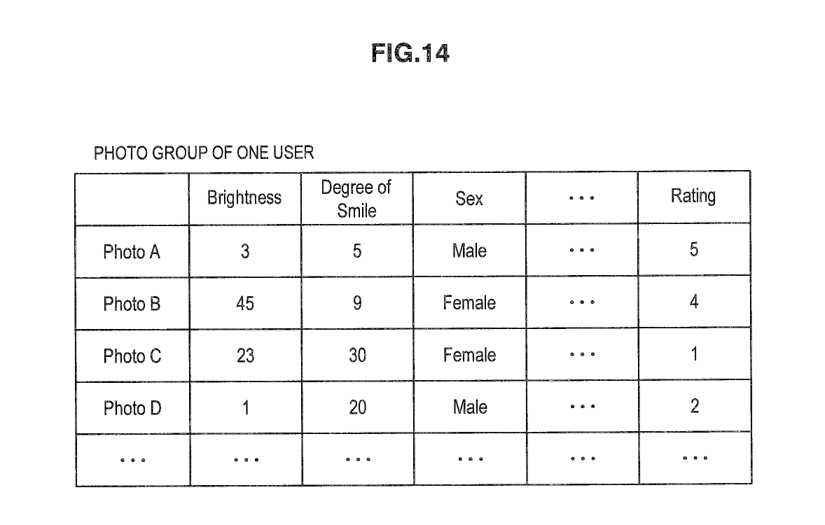

Hereinafter, the creation of the prediction model will be described with specific examples. FIG. 14 is a diagram showing examples of pieces of metadata extracted from a photo group of one user. As shown in FIG. 14, from Photos A to D, pieces of metadata such as brightness, a degree of smile, and a sex (feature quantity vectors which are a score of luminance metadata and a score of subject metadata, which may include both qualitative variables and quantitive variable) are acquired. Then, the user is asked to explicitly evaluate (perform rating of) Photos A to D. A regression model or a classification model is created on the basis of those pieces of data, and thus, metadata having a high degree of contribution to the rating can be found. Further, the created model is evaluated (recall, precision, accuracy) by cross variation or the like, and good or bad of the model can be determined.

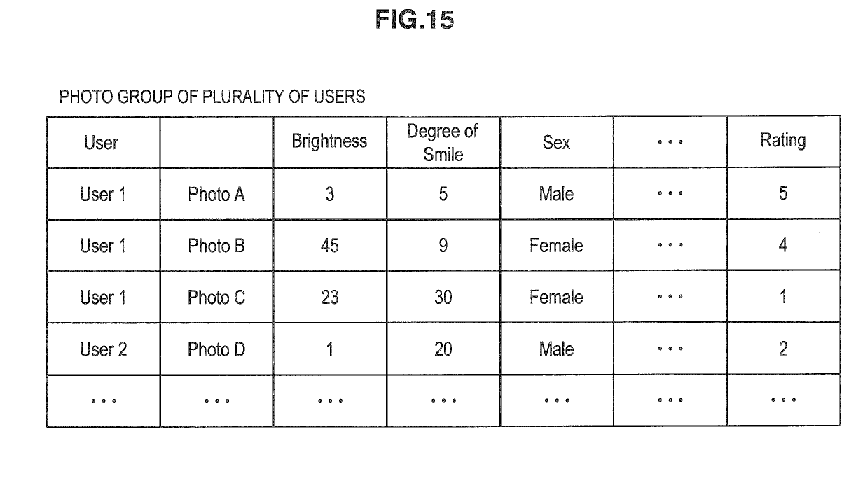

Further, also a prediction model can be created on the basis of test results of a plurality of users. FIG. 15 is a diagram showing examples of pieces of metadata extracted from a photo group of a plurality of users. As shown in FIG. 15, pieces of metadata are extracted from the photo group of the plurality of users (User 1, User 2, . . . ), and each user is asked to explicitly perform rating. Then, by analyzing the constructions of pieces of metadata and the ratings, metadata having a high degree of contribution to the rating that is common to the plurality of users can be found. The plurality of users are extracted as similar people as a result of performing clustering based on user attributes which are obtained by carrying out a questionnaire survey in advance, or extracted as people who have similar way of usage by performing clustering on the operation logs, so that the variation of the scores of pieces of metadata (feature quantity vectors) may become small.

Since a technique of analyzing the constructions of pieces of metadata and the ratings can be performed in the same manner as the technique of analyzing the operation logs and the ratings in the iScore-accuracy enhancement, the description thereof will be omitted.

### 4. EXAMPLE OF PRACTICAL USE OF SCORES

Heretofore, there has been described representing a degree of user's preference with respect to photo content by a score (calculation of iScore and aScore). Subsequently, practicable use cases using a calculated score (iScore or aScore, or a score obtained by multiplying those by a mixed weight) will be described with reference to a plurality of specific examples.

<4-1. Presentation Control>

First, there will be described control of displaying (presenting) photo content in accordance with a user's preference on the basis of a score performed by the display controller (presentation controller) 216 of the user terminal 2.

(4-1-1. Making One Piece of Top-Scored Photo Content Front Cover)

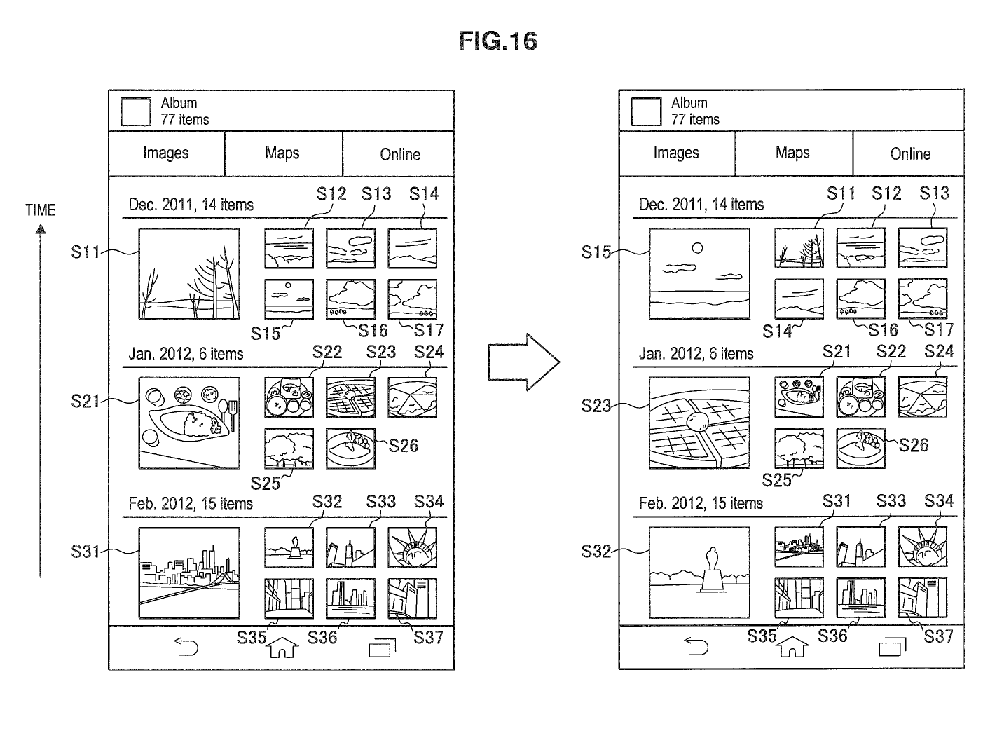

FIG. 16 is a diagram illustrating a case where top-scored (favorite) photo content is set to a front cover in a photo content list screen. As shown in the left-hand side of FIG. 16, in the case where the monthly or yearly photo content list screen is displayed, photo content thumbnail images S11 to S17, S21 to S26, and S31 to S37 are generally displayed in descending/ascending order in time-series (to be specific, shooting time). In this case, the first photo content is displayed as a front cover image in a size larger than the size of the other pieces of photo content included in the corresponding month.

On the contrary, in the present embodiment, the display controller 216 performs display control such that, on the basis of the scores (iScores or aScores, or scores obtained by multiplying those by a mixed weight) representing the preferences of the respective pieces of photo content, the top photo content is displayed as the front cover. To be specific, as shown in the right-hand side of FIG. 16, the display controller 216 selects the thumbnail images S15, S23, and S32 which are the pieces of top-scored photo content among the respective months, and performs control such that the thumbnail images S15, S23, and S32 are each displayed as the front cover in a size larger than the size of the other pieces of photo content.

In this way, in the case of displaying the photo content list screen, there is a merit for the user that the user's favorite photograph is automatically used for the front cover image that catches the user's eye.

(4-1-2. Arranging Pieces of Content in Order of Score)

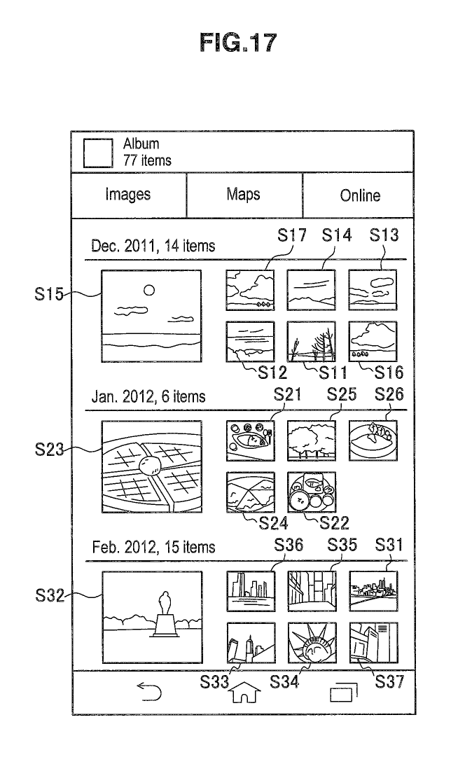

FIG. 17 is a diagram illustrating a case where pieces of photo content are arranged in order of score (order of preference) in a photo content list screen. As shown in the left-side hand side of FIG. 16 described above, the photo content thumbnail images are generally displayed in time-series order.

On the contrary, in the present embodiment, the display controller 216 performs display in a manner that the photo content thumbnail images are arranged in order based on the scores (iScores or aScores, or scores obtained by multiplying those by a mixed weight) representing the preferences of the respective pieces of photo content. To be specific, for example, as shown in FIG. 17, in the case where the magnitude relation between scores of the photo content thumbnail images S11 to S16 is S15>S17>S14>S13>S12>S11>S16, the photo content thumbnail images are displayed in the order of S15, S17, S14, S13, S12, S11, and S16.

In this way, in the case of displaying the photo content list screen, there is a merit for the user that the pieces of photo content are automatically displayed in order of the user's preference, so that the user can view a large number of pieces of photo content in order of preference.

(4-1-3. Highlighting Plurality of Pieces of Top-Scored Photo Content)

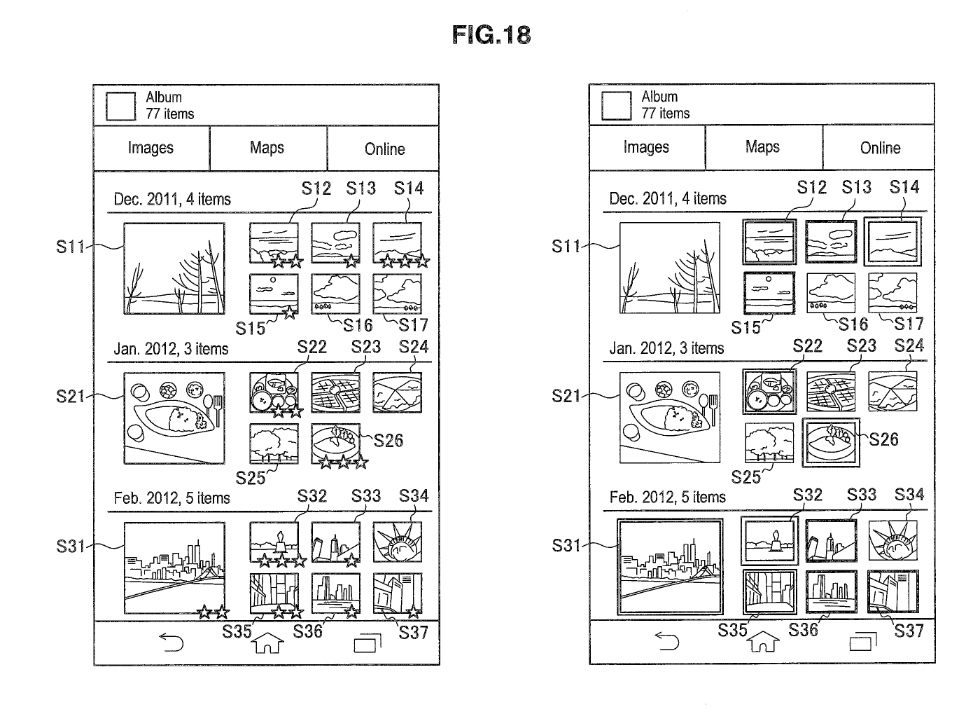

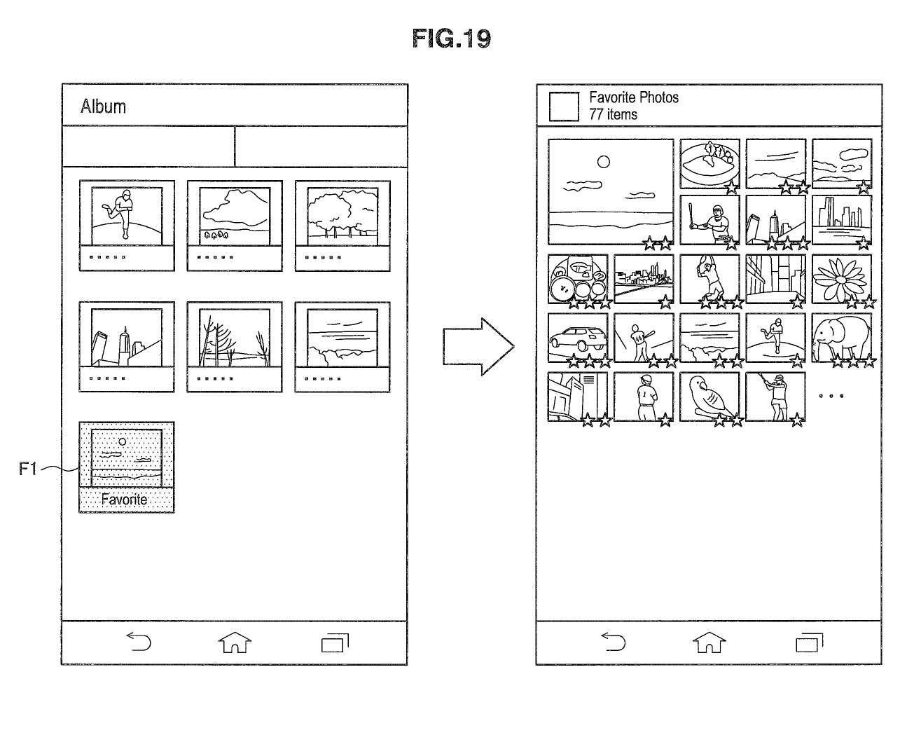

FIG. 18 is a diagram illustrating a case where pieces of top-scored (favorite) photo content are highlighted in a photo content list screen.

In the example shown in the left-hand side of FIG. 18, a top-scored photo content thumbnail image is provided with star mark(s), the number of which corresponding to the order of score. To be specific, as shown in the left-hand side of FIG. 18, three star marks are provided to the photo content thumbnail image S14 having the highest score, two star marks are provided to the thumbnail image S12 having the second highest score, and one star mark is provided to each of the thumbnail images S13 and S15 each having the third highest score, for example.

In the example shown in the right-hand side of FIG. 18, a top-scored photo content thumbnail image is provided with a highlighted frame. To be specific, as shown in the right-hand side of FIG. 18, the photo content thumbnail image S14 having the highest score has the thickest frame, the thumbnail image S12 having the second highest score has the second thickest frame, and the thumbnail images S13 and S15 each having the third highest score each have the third thickest frame, for example.

In this way, in the case of displaying the photo content list screen, there is a merit for the user that user's favorite photo content is automatically highlighted, so that it becomes easier for the user to find the favorite content from a large number of pieces of photo content. Note that the highlight method shown in FIG. 18 is an example, and the highlight method according to the present embodiment is not limited thereto.

(4-1-4. Creating Folder for Top-Scored Photo Content)

FIG. 19 is a diagram illustrating a case where a folder of top-scored (favorite) photo content is created. As shown in the left-hand side of FIG. 19, the display controller 216 automatically creates and displays a favorite folder F1 as a folder for top-scored photo content. When the “favorite folder” is selected, a list of pieces of top-scored photo content (each having a score of a given value or more) is displayed in the folder shown in the right-hand side of FIG. 19.

In this way, there is a merit for the user that only the pieces of favorite photo content can be viewed collectively from among a large number of pieces of photo content.

(4-1-5. Displaying Photographs of Favorite Friends)

Further, in the case of displaying pieces of photo content sent from other users, the display controller 216 according to the present embodiment can also perform control in a manner that photo content of a favorite user among the other users is preferentially displayed using preference with respect to the other users based on the degree of interchange and the degree of intimacy in the SNS or the like.

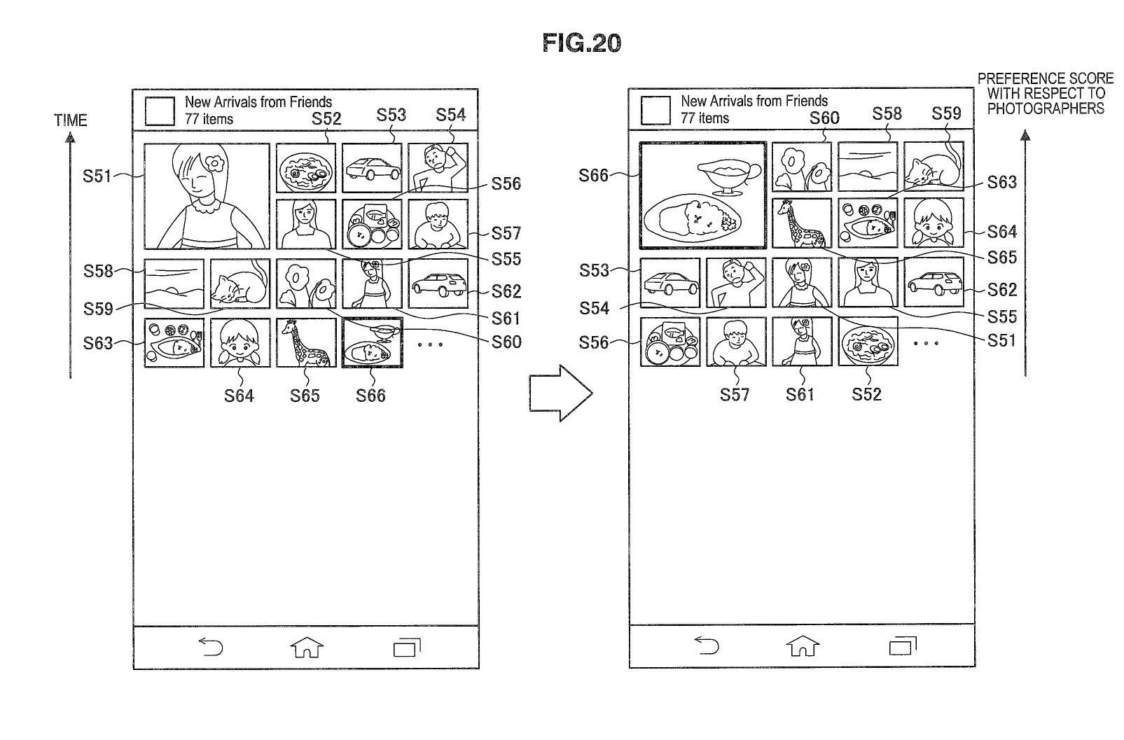

To be specific, for example, using the above-mentioned Equation 3, iScores taken into account the degree of similarity (to be specific, degree of interchange, degree of intimacy) to the other users are calculated, a score with respect to the photo content of a user having a high degree of similarity is calculated to be high, and the pieces of photo content sent from the other users are displayed in order based on the scores. Note that the user here represents a person who took the photo content or a contributor. Hereinafter, a specific example will be shown with reference to FIG. 20.

FIG. 20 is a diagram illustrating a case where, in a photo content list screen sent by other users, photo content of a favorite user among the other users is preferentially displayed. As shown in the left-hand side of FIG. 20, the photo content thumbnail images are generally displayed in time-series order (for example, in order of new arrivals). In this case, a photo content thumbnail image S66 that is sent from a favorite user among the other users is buried in other thumbnail images S51 to S65.

On the contrary, in the present embodiment, the display controller 216 displays the photo content thumbnail images in order based on iScores calculated taken into account the degree of similarity (degree of interchange, degree of intimacy) to a person who took the photo content or a contributor of the photo content. Further, aScore is calculated for unknown photo content (in which the operation log does not exist), and in this case, a degree of similarity between the photo content having top iScore and metadata of the person who took the photo content is calculated as aScore.

In this way, as shown in the right-hand side of FIG. 20, there is a merit for the user that the thumbnail images S51 to S66 are displayed in accordance with scores of preferences with respect to the persons who took the pieces of photo content, and that the photo content thumbnail image S66 sent from the favorite other user can be preferentially viewed.

(4-1-6. Classifying Pieces of Unknown Photo Content)

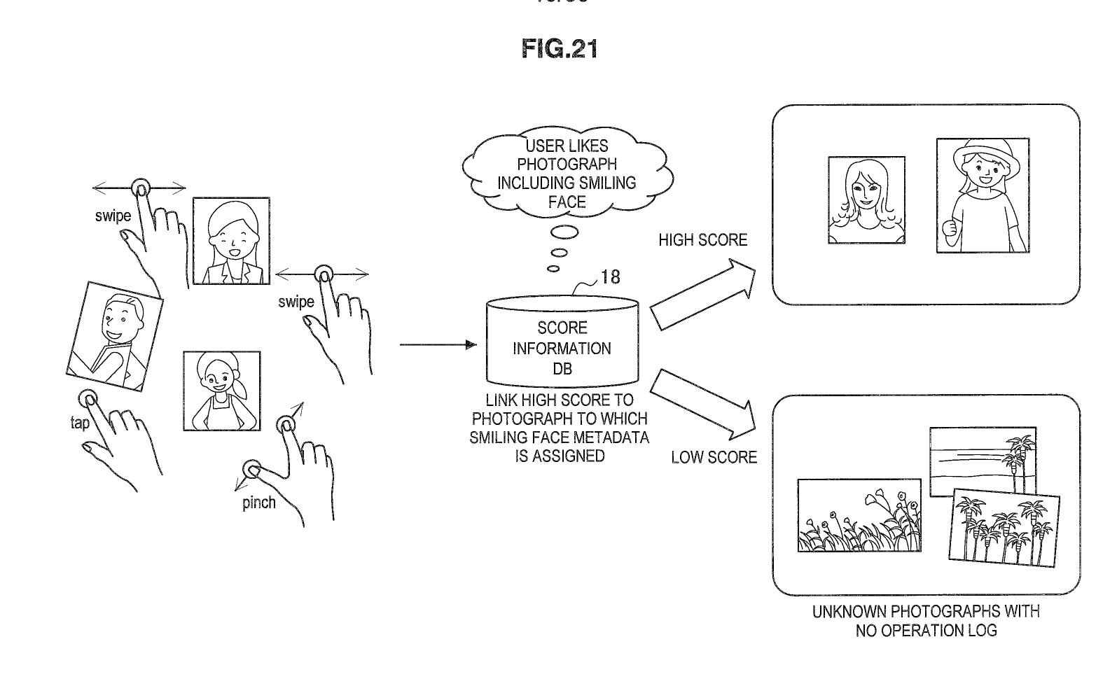

FIG. 21 is a diagram illustrating a case where pieces of unknown photo content are classified into photo content that a user likes and the other photo content. To be specific, for example, as shown in the left-hand side of FIG. 21, in the case where many operation logs such as tap, pinch, and swipe are acquired with respect to pieces of photo content each including a smiling face, since it is identified that the user tends to like photo content including a smiling face, the score calculation part 113 increases the weight of the smiling face metadata and calculates a score of each photo content.

In this way, in the present embodiment, high aScore is linked to the unknown photo content to which the smiling face metadata is assigned, and, as shown in the right-hand side of FIG. 12, the pieces of unknown photo content in which the operation logs do not exist can be distinguished between the pieces of photo content each including a smiling face that the user prefers and the pieces of photo content that the user does not like, on the basis of the levels of the scores.

(4-1-7. Automatically Selecting and Presenting Candidates to be Shared with Specific User)

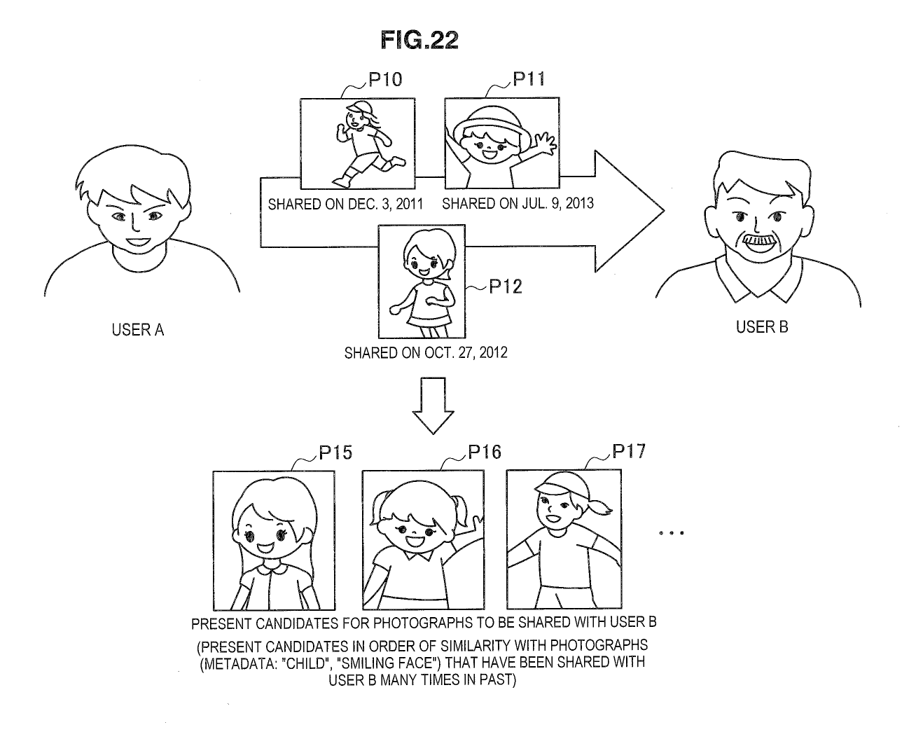

Further, the display controller 216 according to the present embodiment is also capable of presenting candidates for pieces of photo content to be shared with another user on the basis of the user preference. Hereinafter, description will be given with reference to FIG. 22.

FIG. 22 is a diagram illustrating presentation of candidates for pieces of photo content to be shared with a specific user. As shown in FIG. 22, since what sort of pieces of photo content a user A has been sharing with a user B can be found out on the basis of operation logs that the user A has shared with (transmitted to) the user B, the display controller 216 presents unshared (untransmitted) photo content as a sharing candidate in accordance with the degree of similarity with metadata that is common to those pieces of photo content.

To be more specific, the display controller 216 extracts, on the basis of iScores of the respective pieces of photo content that have been calculated by assigning a weight to sharing operation with respect to the user B, metadata that is common to the pieces of photo content having top iScore (of more than or equal to a threshold). In the example shown in FIG. 22, as the pieces of metadata that are common to the pieces of photo content P10 and P11, “child metadata” and “smiling face metadata” are extracted.

Then, among the pieces of photo content which have no sharing operation log (or which have not been shared yet), the display controller 216 extracts pieces of photo content P15 to P17 that are similar to the common metadata, and the pieces of photo content P15 to P17 are presented as the candidates to be shared in order of similarity (in decreasing order of aScore). In this way, the pieces of photo content having the same tendency as the pieces of photo content shared with the other specific user are automatically extracted from a large number of pieces of photo content and presented as candidates to be shared, and thus, the user can save the effort for finding the photo content.

(4-1-8. Presenting Pieces of Favorite Photo Content Out of Large Number of Pieces of Shared Photo Content)

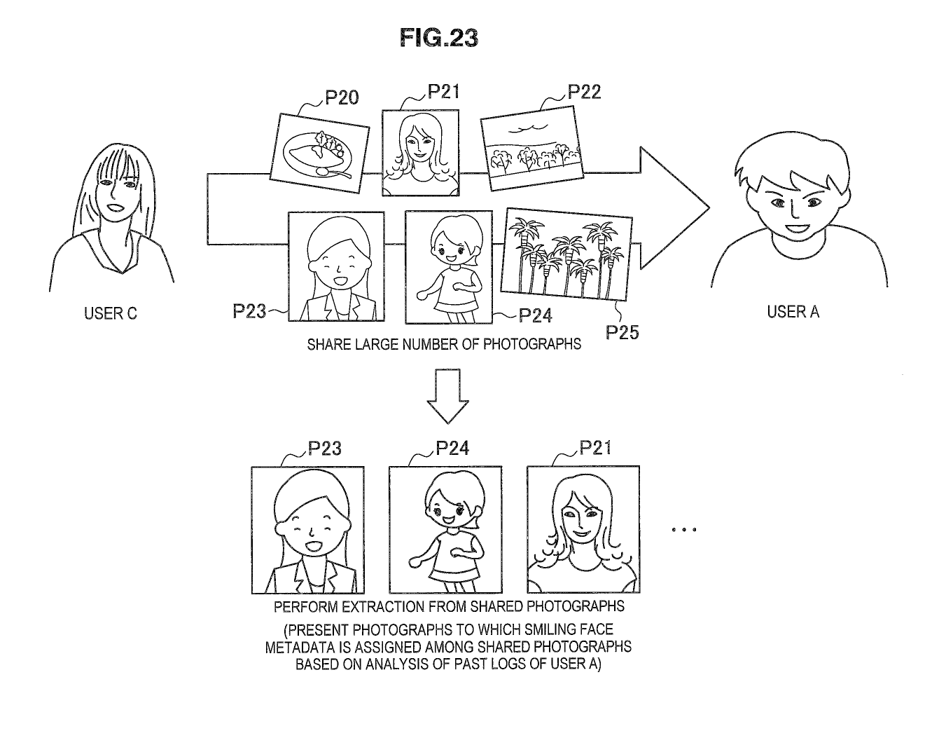

Further, the display controller 216 according to the present embodiment is also capable of extracting and presenting pieces of user's favorite photo content out of a large number of pieces of unoperated photo content shared by another user in accordance with the user preference. Hereinafter, description will be given with reference to FIG. 23.

FIG. 23 is a diagram illustrating a case where pieces of photo content that a user likes are extracted and presented from a large number of pieces of photo content shared by another user. As shown in FIG. 23, for example, in the case where a user C shares (transmits) a large number of pieces of photo content P20 to P25 with (to) the user A, it takes a long time for the user A to view all pieces of photo content.

Accordingly, the display controller 216 according to the present embodiment extracts and presents the pieces of user's favorite photo content out of the large number of pieces of photo content in accordance with the user preference based on the result obtained by analyzing the past operation log of the user A.

To be specific, the display controller 216 performs control in a manner that the pieces of shared photo content are presented in order of similarity (in decreasing order of aScore) between photo content having top iScore (user preference), which is calculated on the basis of the operation log of the user A, and the metadata.

For example, in the case where all pieces of photo content having top iScores are photographs each including a smiling face, the user preference that “the user A likes a smiling face” becomes clear, and the pieces of photo content P23, P24, and P21 are preferentially presented, which have metadata similar to the pieces of photo content having top iScores (which have smiling face metadata).

In this way, even in the case where the large number of pieces of photo content are shared by another user, there is a merit for the user that the pieces of user's favorite photo content are preferentially presented automatically.

(4-1-9. Presenting Pieces of Photo Content Each Including Favorite Person)

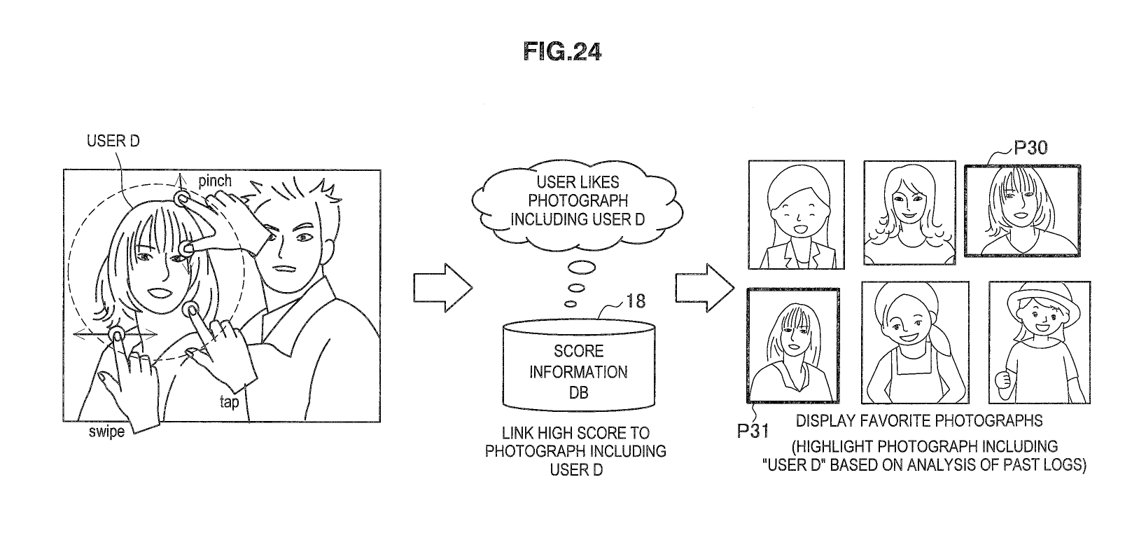

Further, the display controller 216 according to the present embodiment can highlight pieces of photo content each including a user's favorite person based on an operation log (or, displaying only pieces of photo content each including a favorite person). Hereinafter, description will be given with reference to FIG. 24.

FIG. 24 is a diagram illustrating a case where pieces of photo content each including a favorite person are highlighted. As shown in FIG. 24, by analyzing an operation log with respect to photo content such as a tap operation, a swipe operation, and a pinch operation, and combining the analyzed operation log with person metadata of the photo content, a person that the user prefers may be grasped. The score calculation part 113 assigns a weight to the metadata of the person that the user prefers and calculates a score (iScore, aScore) of each piece of photo content. For example, as shown in FIG. 24, in the case where a large number of operation logs with respect to a “user D” are detected (in the case where the person metadata common to pieces of photo content each having top iScore is the “user D”), the user preference that “the user D is preferred” becomes clear.

Then, as shown in the right-hand side of FIG. 24, the display controller 216 perform control in a manner that pieces of photo content (pieces of photo content to which person metadata “user D” is assigned) P30 and P31, which have metadata similar to the pieces of photo content each having top iScore are highlighted (displayed with thick frames or the like) among the large number of pieces of photo content.

In this way, there is a merit for the user that the pieces of photo content each including a person that the user prefers can be easily found among the large number of pieces of photo content. Note that the analysis of user's preference using the combination of the operation log and the metadata is not limited to the case of the person metadata, and may also be performed in the same manner for the case of object metadata.

(4-1-10. Presenting Pieces of Information of Belongings of Favorite Person)

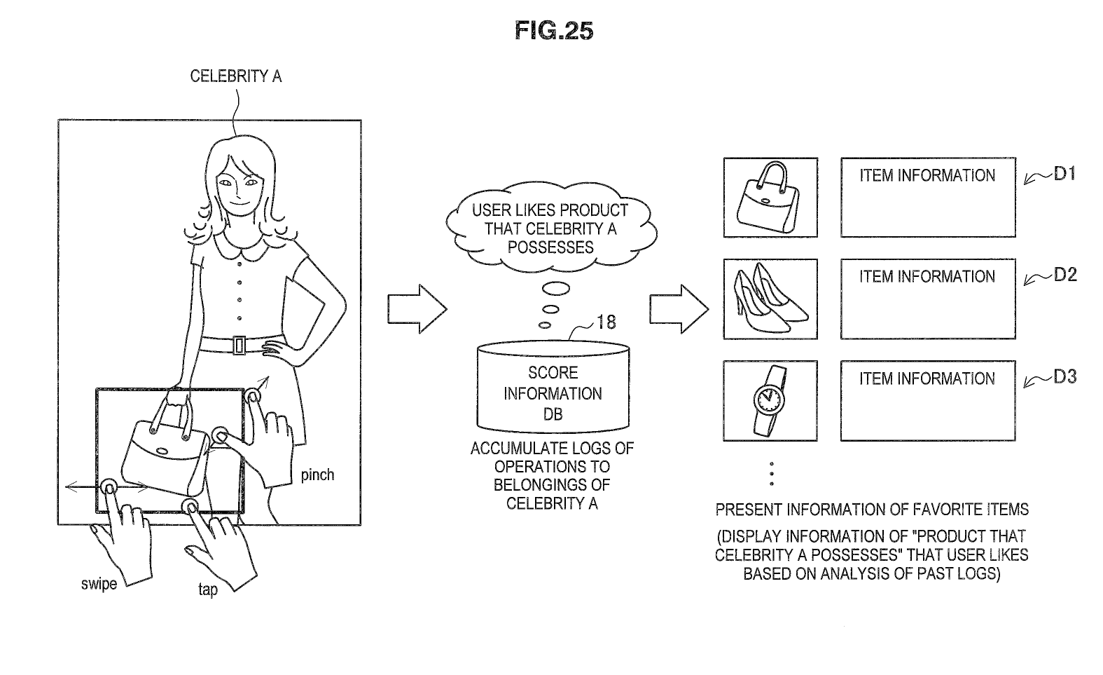

Further, the display controller 216 according to the present embodiment can also perform control in a manner that pieces of information related to belongings of a person that a user prefers are presented. Hereinafter, description will be given with reference to FIG. 25.

FIG. 25 is a diagram illustrating a case where pieces of information related to belongings of a favorite person are presented. Here, by analyzing an operation log with respect to photo content such as a tap operation, a swipe operation, and a pinch operation, and combining the analyzed operation log with person metadata of the photo content, it is clear that the user prefers a “celebrity A”. In addition, with the accumulation of operation logs related to products (bag, watch, shoes, and the like) that the “celebrity A” possesses, it is clear that the user tends to prefer the belongings of the “celebrity A”.

In this case, the display controller 216 performs control in a manner that the display controller 216 references product metadata of the photo content having top iScore (photo content to which the metadata of “celebrity A” is assigned), acquires pieces of information D1 to D3 related to belongings of the celebrity A from a network, and presents the pieces of information D1 to D3 in a manner as shown in the right-hand side of FIG. 25.

In this way, there is a merit for the user that the pieces of item information related to the belongings of the celebrity A whom the user prefers are automatically presented.

<4-2. Backup Control>

Next, description will be given about the backup controller 217 of the user terminal 2 performing control such that photo content is backed up in a given cloud server 3 on the basis of a score.

(4-2-1. Automatically Backing Up Favorite Photo Content)

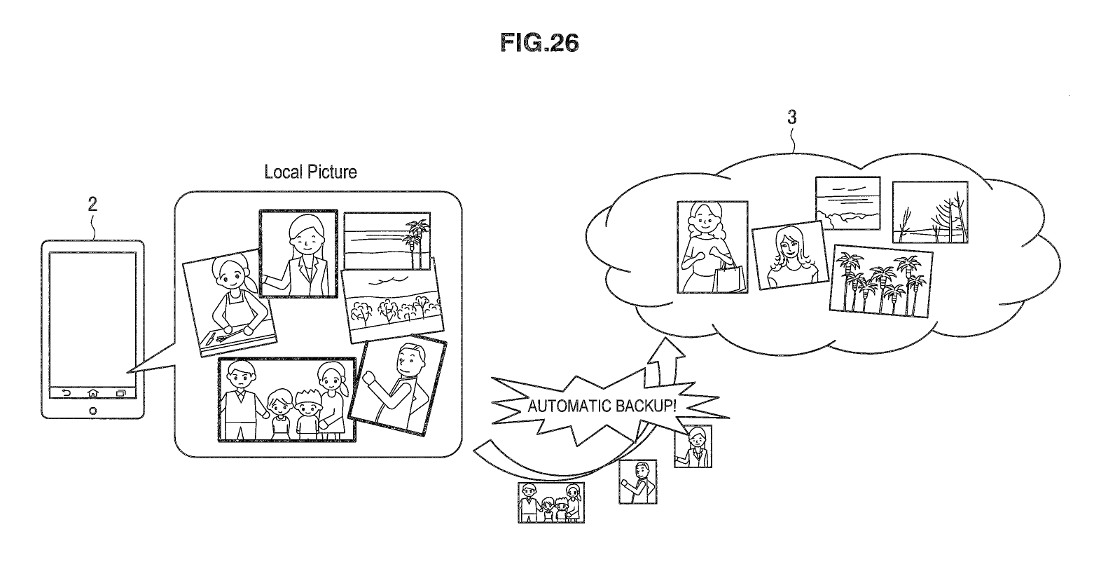

FIG. 26 is a diagram illustrating a case where pieces of favorite photo content are automatically backed up. As shown in FIG. 26, the backup controller 217 automatically transmits to the given cloud server 3 pieces of user's favorite photo content preferentially (or, only pieces of favorite photo content) among a large number of pieces of photo content (hereinafter, also referred to as local pictures) stored in the storage 26, which is local memory of the user terminal 2, and thus performs backup control.

That is, the backup controller 217 performs control such that pieces of photo content each having a top photo content score (iScore or aScore, or a score obtained by multiplying those by a mixed weight) are transmitted to the cloud server 3.

In this way, there is a merit for the user that the user can use the cloud server 3 more effectively even in the case where the cloud server 3 has a storage limitation, for example. Further, in the case where data of the user terminal 2 is lost, restoration can be executed since at least the pieces of favorite photo content are automatically saved in the cloud server 3.

(4-2-2. Saving Locally Favorite Photo Content)

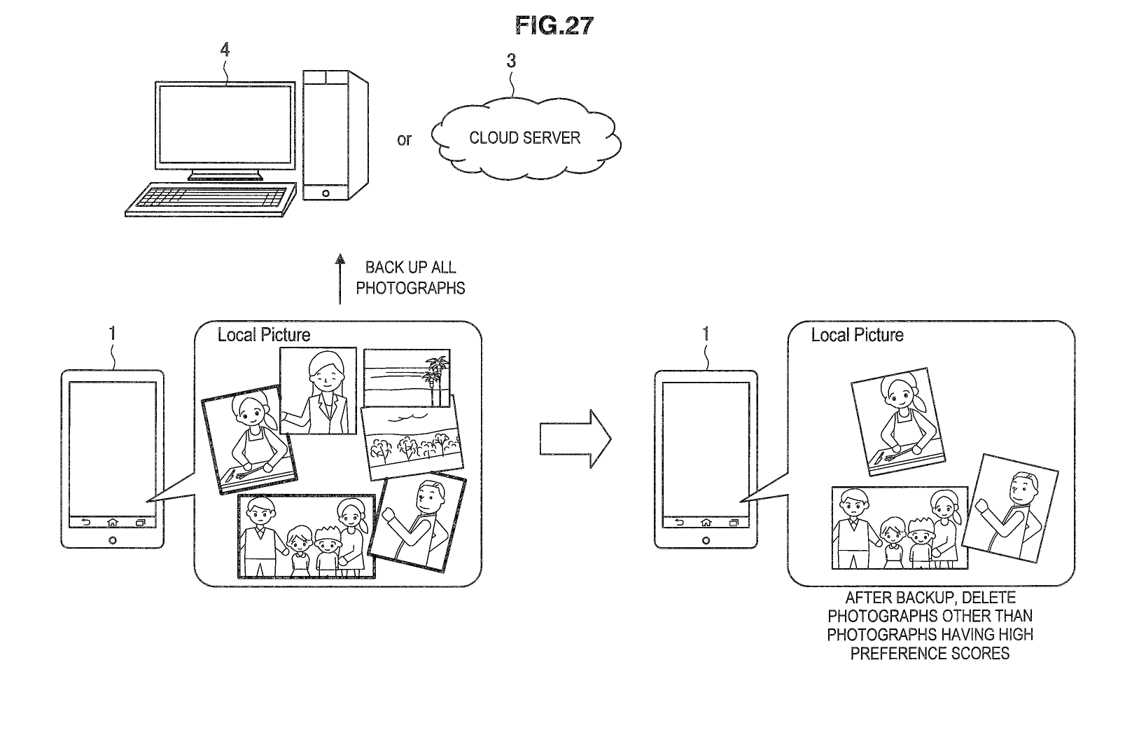

FIG. 27 is a diagram illustrating a case where pieces of favorite photo content are saved locally. In order to reduce pressure on the capacity of the user terminal 2 (client terminal), the user may transmit a large number of pieces of photo content stored in the user terminal 2 to the given cloud server 3, a PC 4, or the like, to thereby perform the backup. In this case, there is an inconvenience that past photo content could not be seen locally later in the case where the user wants to see the past photo content on the user terminal 2.

Accordingly, as shown in FIG. 27, first, the backup controller 217 according to the present embodiment performs backup by transmitting all local pictures of the user terminal 2 to the given cloud server 3 or the PC 4. After that, the backup controller 217 performs control in a manner that the pieces of photo content other than the user's favorite photo content, that is, the pieces of photo content other than the top-scored photo content, are automatically deleted from the storage 26 (local memory).

In this way, since the favorite (top-scored) photo content is saved locally (in the storage 26), there is a merit for the user that the favorite photo content can be viewed locally at any time anywhere.

### 5. APPLICATION TO CONTENT RECOMMENDATION

Heretofore, the presentation control and the backup control of the pieces of photo content based on the scores have been described, but the present embodiment is not limited thereto. The present embodiment can also be applied to recommendation of other pieces of content (pieces of game content, pieces of video content, items such as books) in accordance with the scores of the pieces of photo content. Hereinafter, description will be given with reference to a plurality of specific examples.

<5-1. Collaborative Filtering (CF)-Based Content Recommendation>

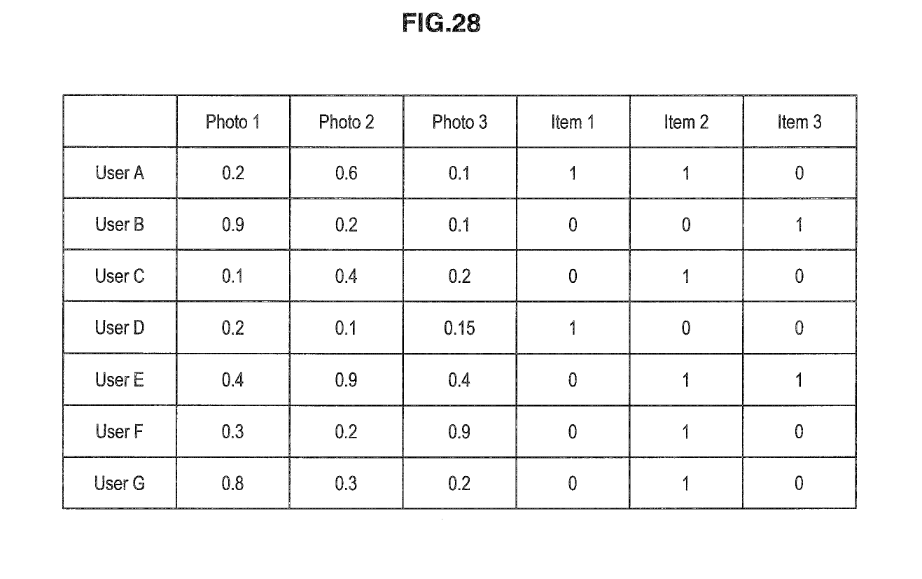

The analysis processing part 10 according to the present embodiment looks up the co-occurrence between iScore based on an operation log of photo content and a purchase log, and can perform item recommendation like “User who looks at this photograph purchases this item”. Note that it is also possible to perform photograph recommendation like “User who purchases this item looks at this photograph”. Further, as a premise of the present embodiment, the photo content is at a public place such as SNS, and can be seen by anybody. Hereinafter, with reference to FIGS. 28 to 32, calculation of a relation score between photo content and an item, and recommendation of content (item) will be described.

FIG. 28 is a table in which scores with respect to pieces of photo content of each user and item purchase logs of each user are normalized. To be more specific, the scores of the pieces of photo content (Photos 1 to 3) are obtained by normalizing Item-based Scores, and the values of items (Items 1 to 3) are obtained by normalizing purchase logs (purchased: 1, not purchased: 0).

The analysis processing part 10 calculates a relation score between photo content and an item using an item-base (method of working out a degree of association between items) or a user-base (method of working out a degree of association between users). The calculation of a relation score can be performed using a Jaccard coefficient or an inner product. However, since the example shown in FIG. 28 includes values other than a binary value, the calculation is performed using an inner product. It is also possible to perform calculation using a Jaccard coefficient in the case where the score of the photo content is converted into a threshold 0/1.

The following Table 2 shows a calculation example shown in FIG. 28 of relation scores based on scores of pieces of photo content and item logs.

TABLE 2

| | Item | Item | Item | Item | Item | Item | Item | Item | Item |
|---|---|---|---|---|---|---|---|---|---|
| | 1 | 2 | 3 | 1 | 2 | 3 | 1 | 2 | 3 |
| | Photo 1 to Items | | | Photo 2 to Items | | | Photo 3 to Items | | |
| User A | 0.2 | 0.2 | 0 | 0.6 | 0.6 | 0 | 0.1 | 0.1 | 0 |
| User B | 0 | 0 | 0.9 | 0 | 0 | 0.2 | 0 | 0 | 0.1 |
| User C | 0 | 0.1 | 0 | 0 | 0.4 | 0 | 0 | 0.2 | 0 |
| User D | 0.2 | 0 | 0 | 0.6 | 0 | 0 | 0.15 | 0 | 0 |
| User E | 0 | 0.4 | 0.4 | 0 | 0.9 | 0.9 | 0 | 0.4 | 0.4 |
| User F | 0 | 0.3 | 0 | 0 | 0.2 | 0 | 0 | 0.9 | 0 |
| User G | 0 | 0.8 | 0 | 0 | 0.3 | 0 | 0 | 0.2 | 0 |
| | 0.057 | 0.257 | 0.186 | 0.171 | 0.343 | 0.157 | 0.036 | 0.257 | 0.071 |

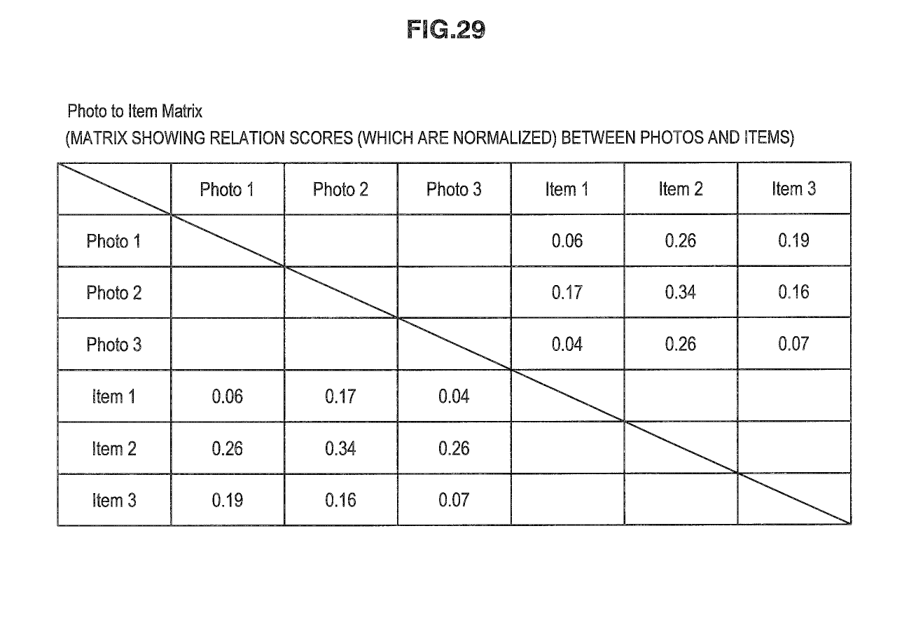

Further, based on the calculation results shown in Table 2, FIG. 29 shows relation scores between pieces of photo content and items in a matrix. As shown in FIG. 29, the relation scores (which are normalized) between the pieces of photo content (Photos 1 to 3) and the items (Items 1 to 3) are calculated.

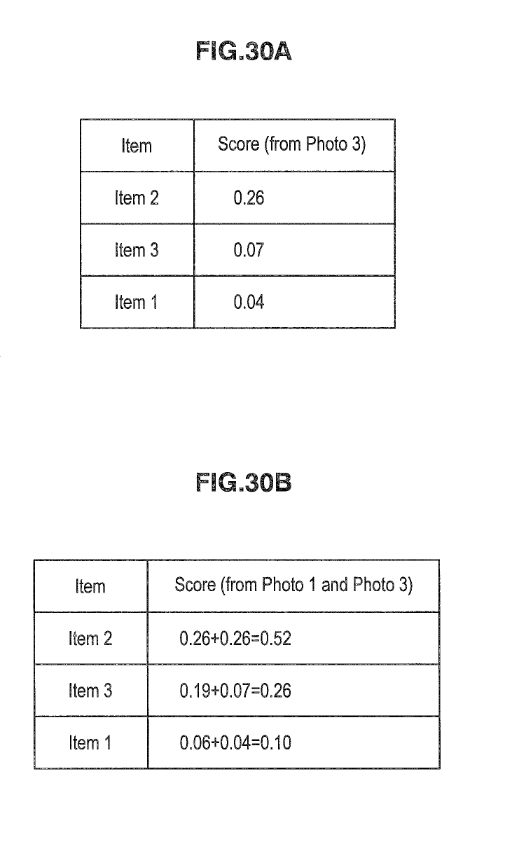

Examples of practical use based on the relation scores will be described with reference to FIG. 30A and FIG. 30B. First, FIG. 30A is a table in which relation scores between items and one piece of photo content are extracted and arranged in order of relation score. As shown in FIG. 30A, referring to the relation scores of Items 1 to 3 with respect to Photo 3, it is found out that the user who prefers Photo 3 purchases Item 2, and hence, the display controller 216 recommends Item 2 to the user who prefers Photo 3. Note that, whether or not the user prefers Photo 3 may be determined based on whether the score (iScore, aScore) of the photo content exceeds a given threshold. For example, the display controller 216 determines that the user prefers the photo content when iScore of the photo content is 0.8 or more.

FIG. 30B is a table in which relation scores between items and a plurality of pieces of photo content are extracted and arranged in order of relation score. As shown in FIG. 30B, referring to the values obtained by adding the relation scores of Items 1 to 3 with respect to Photo 1 and relation scores of Items 1 to 3 with respect to Photo 3, respectively, it is found out that the user who prefers Photo 1 and Photo 3 purchases Item 2. Accordingly, the display controller 216 recommends Item 2 to the user who prefers Photo 1 and Photo 3.

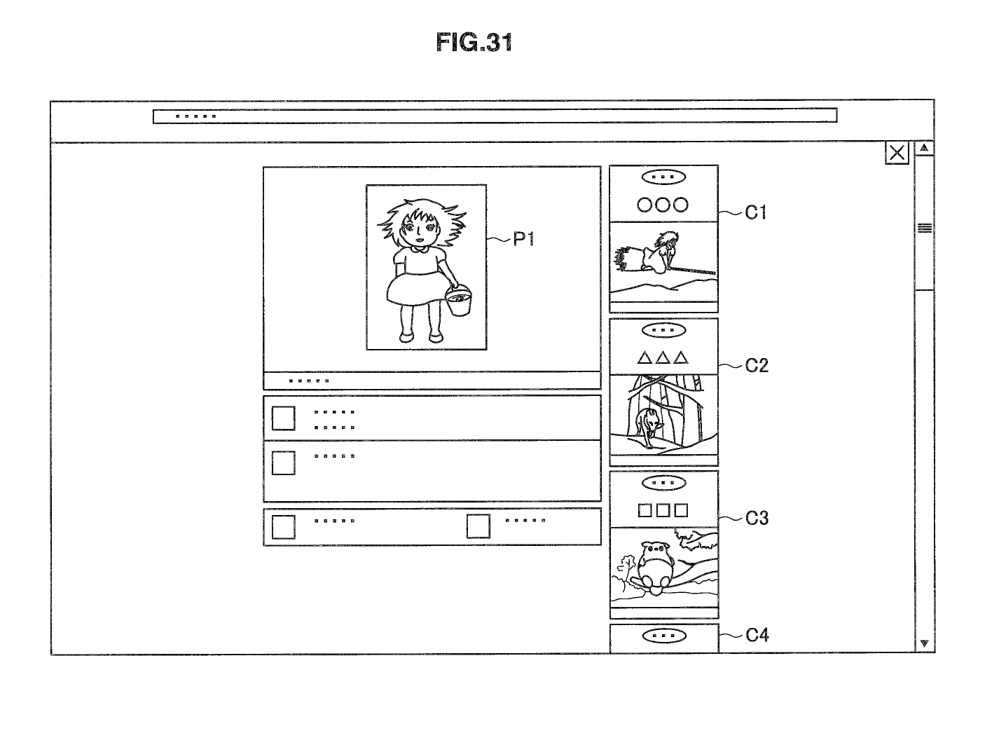

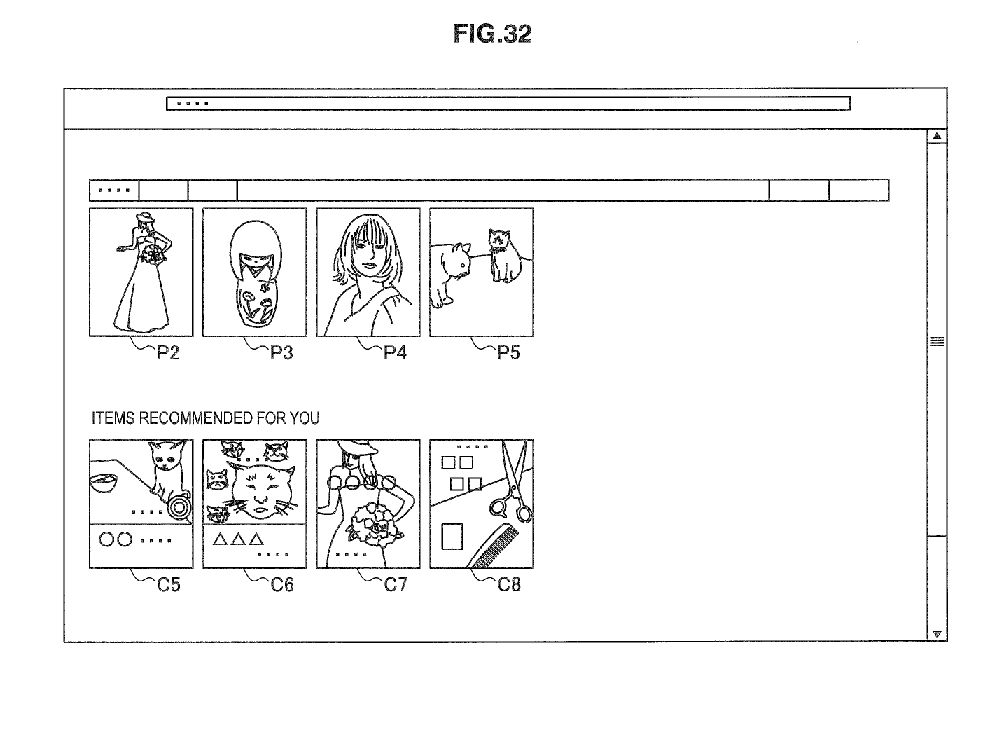

Subsequently, with reference to FIG. 31 and FIG. 32, examples of UI's in the case of recommending items will be described. FIG. 31 is a diagram showing a screen display example in a case where related items are displayed at a time of viewing photo content P1. As shown in FIG. 31, when the photo content P1 is displayed, the display controller 216 performs control in a manner that, for example, front cover images of pieces of video content C1 to C4 are displayed next to the photo content P1, as items (Photo to Item) that a user who prefers photo content P1 purchases.

FIG. 32 is a diagram showing a screen display example in which items each related to photo content having high iScore are recommended to a user. As shown in FIG. 32, the display controller 216 performs control in a manner that items related to a photo content group (pieces of photo content P2 to P5) each having high iScore, for example, front cover images of pieces of book content C5 to C8, are displayed as items (User to Item) to be recommended to the user.

<5-2. Content-Based Filtering (CBF)-Based Content Recommendation>

Further, in the present embodiment, using an operation log and metadata of photo content, it is also possible to perform recommendation of content which a person who frequently appears in photo content having high Item-based Score takes part in and content which is related to an object that frequently appears in photo content having high Item-based Score.

It is assumed that, since the user prefers the target person and the target object, the user looks at and performs enlarging operation on the photo content in which the target person or the target object frequently appears. Accordingly, the content related to the person or the object is recommended to the user, to thereby recommend the content corresponding to the user's preference.

<5-3. CF/CBF-Based Content Recommendation>

Further, in the present embodiment, it is also possible to perform recommendation of content by mixing the CF-based content recommendation and the CBF-based content recommendation, the content having characteristics of the both CF-based content recommendation and the CBF-based content recommendation. Hereinafter, there will be described a case where items related to photo content are recommended and a case where items related to a user are recommended.

(5-3-1. Recommendation of Items Related to Photo Content)

First, there will be described steps of the case where items related to target photo content are recommended (Photo to Item). Note that the number of the recommended items is represented by N.

(Step 1)

A relation score calculated with the CF base and a relation score calculated with the CBF base are each normalized.

(Step 2)

Subsequently, when a mixture ratio of CF to CBF is represented by a:b, from a CF-derived item score list and a CBF-derived item score list, the item scores being calculated in Step 1, the item score lists each being a map of items and relation scores, the top N*a/(a+b) scores and the top N*b/(a+b) scores are extracted, respectively, and the mixture thereof is set as a recommendation item score list.

(Step 3)

Then, based on the created recommendation item score list, the items related to the target photo content are recommended.

(5-3-2. Recommendation of Items Related to User)

Next, there will be described steps of the case where items related to a target user are recommended (User to Item). Note that the number of the recommended items is represented by N.

(Step 11)

For a photo content group having high Item-based Score of the target user, a recommendation item score list in which the photo content group is overlapped is generated using a CF-based Photo to Item matrix (the matrix showing relation scores between pieces of photo content and items as shown in FIG. 29).

(Step 12)

Next, for a photo content group having high Item-based Score of the target user, a recommendation item score list in which the photo content group is overlapped is generated using a CBF-based Photo to Item matrix.

(Step 13)

Subsequently, a relation score calculated with the CF base and a relation score calculated with the CBF base are each normalized.

(Step 14)

Next, when a mixture ratio of CF to CBF is represented by a:b, from a CF-derived item score list and a CBF-derived item score list, the item scores being calculated in Step 11, the item score lists each being a map of items and relation scores, the top N*a/(a+b) scores and the top N*b/(a+b) scores are extracted, respectively, and the mixture thereof is set as a recommendation item score list.

(Step 15)

Then, based on the created recommendation item score list, the items related to the target user are recommended.

### 6. CONCLUSION

As described above, the scoring system according to an embodiment of the present disclosure can calculate a score (iScore) showing user's preference by assigning a different weight to an operation log for each user attribute. In this way, even in the case where the operation logs for pieces of photo content are the same, it does not mean that the same scores are calculated, and the scores that attach importance to an operation log having high degree of contribution to the personal preference in accordance with the user attribute are calculated, and hence, more useful user preference can be calculated.

Further, also for the unknown photo content in which the operation log does not exist, a score (aScore) showing preference for content can be calculated by working out the degree of similarity of metadata with content having high iScore. In this way, although only viewing content that has been operated has been used as a target for the process based on value-added information in the related art and it has been difficult to use unoperated content as the target for the process, the present embodiment can use not only the content that has been operated in the past but also the unoperated content as the target for the process. In particular, accumulation of a large amount of data due to sharing of data through life logs and SNS has recently made it difficult for the user to view all pieces of data, and hence, it is more effective that the unoperated content can also be used as the target for the process as in the present embodiment.

It should be understood by those skilled in the art that various modifications, combinations, sub-combinations and alterations may occur depending on design requirements and other factors insofar as they are within the scope of the appended claims or the equivalents thereof.

For example, it is also possible to create a computer program for causing hardware such as a CPU, ROM, and RAM, which are built in the above-mentioned server 1, 1x or the above-mentioned user terminal 2, 2x, 2y, to exhibit the respective functions of the server 1, 1x or the user terminal 2, 2x, 2y. Further, there is also provided a computer-readable storage medium having the computer program stored therein.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.

(1) An information processing apparatus including:

a calculation part configured to calculate a first score based on an operation log with respect to content using a weighting of an operation log that is different for each user attribute; and

a linking part configured to link the calculated first score to the content.

(2) The information processing apparatus according to (1),

wherein, in a case where the content has no operation log, the calculation part calculates a second score based on metadata of the content.

(3) The information processing apparatus according to (2),

wherein the second score is calculated in accordance with a degree of similarity of metadata between target content having no operation log and content for which the first score is calculated.

(4) The information processing apparatus according to (2) or (3),

wherein the metadata used for calculating the second score has strength and weakness.

(5) The information processing apparatus according to any one of (2) to (4),

wherein the metadata includes condition information at a time of creating the content, or at least one of face presence/absence information, person information, and object information.

(6) The information processing apparatus according to any one of (1) to (5),

wherein the user attribute is an attribute based on at least one of an age, a sex, a marital status, a parental status, a usage history of a user terminal, a model of a user terminal, a usage history of a specific service/device, a usage frequency of a specific device, and a usage frequency/method of content.

(7) The information processing apparatus according to any one of (1) to (6),

wherein the weighting of an operation log that is different for each user attribute is determined using a model constructed on the basis of a user test that has been performed in advance.

(8) The information processing apparatus according to any one of (1) to (7),

wherein the calculation part calculates the first score by taking into account a degree of similarity between a user and another user who is a provider of the content.

(9) The information processing apparatus according to any one of (2) to (8), further including

a presentation controller configured to perform control in a manner that the content is presented in accordance with highness of the first score or the second score linked to the content.

(10) The information processing apparatus according to (9),

wherein the presentation controller performs control in a manner that the content is presented, after assigning any weight to each of the first score and the second score, in accordance with the highness of the first score and the second score.

(11) The information processing apparatus according to any one of (1) to (10), further including

a backup controller configured to perform control in a manner that the content is transmitted to a given external storage device to be backed up in accordance with highness of the first score or the second score linked to the content.

(12) The information processing apparatus according to (11),

wherein, in a case where all pieces of content stored in an internal storage are transmitted to the external storage device, the backup controller deletes the content stored in the internal storage in accordance with lowness of the first score or the second score.

(13) A score calculation method including:

calculating a first score based on an operation log with respect to content using a weighting of an operation log that is different for each user attribute; and

linking the calculated first score to the content.

(14) A program for causing a computer to function as:

a calculation part configured to calculate a first score based on an operation log with respect to content using a weighting of an operation log that is different for each user attribute; and

a linking part configured to link the calculated first score to the content.

(15) A system including:

a server including
a calculation part configured to calculate a first score based on an operation log with respect to content using a weighting of an operation log that is different for each user attribute, and
a linking part configured to link the calculated first score to the content; and

a user terminal including
a presentation controller configured to perform control in a manner that the content is presented in accordance with highness of the first score or a second score linked to the content.

What is claimed is:

1. An information processing apparatus comprising:
a calculation part configured to calculate a first score based on an operation log with respect to content using a weighting of an operation log that is different for each user attribute; and
a linking part configured to link the calculated first score to the content.

2. The information processing apparatus according to claim 1,
wherein, in a case where the content has no operation log, the calculation part calculates a second score based on metadata of the content.

3. The information processing apparatus according to claim 2,
wherein the second score is calculated in accordance with a degree of similarity of metadata between target content having no operation log and content for which the first score is calculated.

4. The information processing apparatus according to claim 2,
wherein the metadata used for calculating the second score has strength and weakness.

5. The information processing apparatus according to claim 2,
wherein the metadata includes condition information at a time of creating the content, or at least one of face presence/absence information, person information, and object information.

6. The information processing apparatus according to claim 1,
wherein the user attribute is an attribute based on at least one of an age, a sex, a marital status, a parental status, a usage history of a user terminal, a model of a user terminal, a usage history of a specific service/device, a usage frequency of a specific device, and a usage frequency/method of content.

7. The information processing apparatus according to claim 1,
wherein the weighting of an operation log that is different for each user attribute is determined using a model constructed on the basis of a user test that has been performed in advance.

8. The information processing apparatus according to claim 1,
wherein the calculation part calculates the first score by taking into account a degree of similarity between a user and another user who is a provider of the content.

9. The information processing apparatus according to claim 2, further comprising
a presentation controller configured to perform control in a manner that the content is presented in accordance with highness of the first score or the second score linked to the content.

10. The information processing apparatus according to claim 9,
wherein the presentation controller performs control in a manner that the content is presented, after assigning any weight to each of the first score and the second score, in accordance with the highness of the first score and the second score.

11. The information processing apparatus according to claim 1, further comprising
a backup controller configured to perform control in a manner that the content is transmitted to a given external storage device to be backed up in accordance with highness of the first score or the second score linked to the content.

12. The information processing apparatus according to claim 11,
wherein, in a case where all pieces of content stored in an internal storage are transmitted to the external storage device, the backup controller deletes the content stored in the internal storage in accordance with lowness of the first score or the second score.

13. A score calculation method comprising:
calculating a first score based on an operation log with respect to content using a weighting of an operation log that is different for each user attribute; and
linking the calculated first score to the content.

14. A program for causing a computer to function as:
a calculation part configured to calculate a first score based on an operation log with respect to content using a weighting of an operation log that is different for each user attribute; and
a linking part configured to link the calculated first score to the content.

15. A system comprising:
a server including
a calculation part configured to calculate a first score based on an operation log with respect to content using a weighting of an operation log that is different for each user attribute, and
a linking part configured to link the calculated first score to the content; and
a user terminal including
a presentation controller configured to perform control in a manner that the content is presented in accordance with highness of the first score or a second score linked to the content.
